(19) United States
(12) Patent Application Publication
(10) Pub. No.: US 2026/0028818 A1
(43) Pub. Date: Jan. 29, 2026

(54) WOODEN LOAD-BEARING WALL, METHOD OF CONSTRUCTING WOODEN LOAD-BEARING WALL, METHOD OF INCREASING COEFFICIENT OF EFFECTIVE WALL LENGTH OF WOODEN LOAD-BEARING WALL, AND GYPSUM-BASED LOAD-BEARING BEARING BOARD

(71) Applicant: YOSHINO GYPSUM CO., LTD., Tokyo (JP)

(72) Inventors: Ushio SUDO, Tokyo (JP); Katsumi NIIMI, Tokyo (JP); Tomoya HASEGAWA, Tokyo (JP); Takuji YAMASHITA, Tokyo (JP); Kozo AKAI, Tokyo (JP); Yosuke SATO, Tokyo (JP)

(21) Appl. No.: 18/993,183

(22) PCT Filed: Jun. 15, 2023
(86) PCT No.: PCT/JP2023/022235

§ 371 Date: Jan. 10, 2025

(30) Foreign Application Priority Data
Jul. 30, 2022 (JP) 2022-122390

(51) Int. Cl. E04C 2/04; E04C 2/10

(52) U.S. Cl. CPC E04C 2/04; E04C 2/10

(57) ABSTRACT

Provided is a wooden load-bearing wall including a gypsum-based load-bearing bearing board fastened onto a wooden structure wall base with fasteners. The load-bearing bearing board includes a main material or core material formed of a board-shaped hardened gypsum, and a paper member covering at least front and back surfaces of the main material or core material. The load-bearing bearing board has an area density or weight per unit area of 6.5 to 8.9 kg/m², lateral nail resistance of 500 N or greater, and compressive strength of 6.5 N/mm² or greater. Each of the fasteners is a metal nail including a head portion and body portion. An area ratio of an area of the head portion to a cross-sectional area of the body portion is set at a value of 6 to 13. The load-bearing wall has a value of an ultimate displacement (δu) being greater than 20×10⁻³ rad.

### TECHNICAL FIELD

The present disclosure relates to a wooden load-bearing wall, a method of constructing a wooden load-bearing wall, a method of increasing a coefficient of effective wall length (“Kabe-bairitsu”) of a wooden load-bearing wall, and a gypsum-based load-bearing bearing board. Specifically, the present disclosure relates to a wooden load-bearing wall that uses a gypsum-based load-bearing bearing board of a relative low density, in which a lateral nail resistance is effectively reduce actions, such as breakage or rupture of a nailed portion, or the like, without additionally providing a reinforcement material or stiffener, such as a metal plate or the like; and relates to a method of constructing the wooden load-bearing wall, a method of increasing a coefficient of effective wall length of the wooden load-bearing wall, and a gypsum-based load-bearing bearing board for the wooden load-bearing wall.

### BACKGROUND ART

Generally, construction methods of wooden structure buildings are roughly classified into a wooden framework construction system and a wood framing construction system. Due to the effects of recent large-scale earthquakes, research on the seismic resistance of wooden buildings has been attracting particular attention in Japan in recent years. As described in Patent Document 1 (International Publication No. WO2019/203148A1), in the practice of building design in our country (Japan), a framework length of a bearing wall (a length of a wall in an architectural plan view) effective on the structural strength is generally used as an index for indicating a strength of a wooden structure building against a short-term horizontal load (e.g., seismic force, wind pressure, etc.). For a calculation of the framework length, a coefficient of effective wall length corresponding to a structure of the bearing wall is used. The coefficient of effective wall length is an index of seismic performance or load-bearing performance of a bearing wall. As the larger the numerical value of the coefficient of effective wall length is, the greater the strength against the seismic force is. A wall structure having a large value of a coefficient of effective wall length is advantageous for improving the degree of freedom in design and seismic resistance of an entire building.

The coefficient of effective wall length of general-purpose wooden load-bearing walls that have been used in our country (Japan) for many years are specified in Article 46 of Order of Enforcement for Building Standard Laws of Japan, Notification No. 1100 of the Ministry of Construction (Jun. 1, 1981), and Notification No. 1541 of the Ministry of Land, Infrastructure, Transport, and Tourism (Oct. 15, 2001). For many recent bearing walls that do not belong to such general wall structures, a coefficient of effective wall length needs to be determined based on the definitions approved by the Minister of Land, Infrastructure, Transport and Tourism, defined in Section 46, Paragraph 4, Table 1 (8) of Order of Enforcement for Building Standard Laws of Japan. Therefore, a coefficient of effective wall length of relatively many of wooden load-bearing walls constructed in recent years needs to be set based on a performance test performed by a designated performance evaluation agency, and a test method or the like of the performance test is described in detail in “Wooden bearing walls and operational procedures of testing and evaluating magnifications and performance thereof” or the like, published by various test and inspection agencies.

Patent Document 1 discloses, as a measure for improving a coefficient of effective wall length through increase in ultimate displacement or the like of a bearing wall, a method of reinforcing a board, in which a reinforcement material or a stiffener, such as a metal plate, is provided to a portion to be nailed to prevent a breakage, rupture, or the like of the nailed portion. It is considered that a wooden load-bearing wall using the above reinforcement material or stiffener can improve toughness and conformability on deformation of a bearing board regardless of increase in maximum load that the board can endure so that a ultimate displacement or the like is increased, thereby providing the wooden load-bearing wall having a relatively high coefficient of effective wall length. However, for the bearing wall structure where the ultimate displacement or the like is increased using the reinforcement material or stiffener, a step of additionally attaching a reinforcement material or a stiffener to a surface of a bearing board is added to a board production process, or the above step needs to be additionally performed when a wooden load-bearing wall is constructed. This type of the step makes a production process of a gypsum-based board more complicated, or becomes a factor of impairing workability of construction work.

As a gypsum-based board that can be suitably used as a bearing board of a wooden load-bearing wall, a “gypsum board for structure” has been known. The “gypsum board for structure” is a gypsum-based board obtained by increasing a lateral nail resistance of a “reinforced gypsum board” based on the technology of the present applicant disclosed in Japanese Patent No. 5642948 (Patent Document 2). The lateral nail resistance is a shear strength of a nailed portion of a board as measured by a lateral nail resistance test specified in JIS A 6901. The lateral nail resistance is relatively concretely described in Japanese Patent No. 7012405 (Patent Document 3), which is based on the application applied by the present applicant, and therefore further detailed description thereof is omitted. The lateral nail resistance is a physical property proposed by the applicant suggested as a strength determination factor of a gypsum-based load-bearing bearing board in Patent Document 2, and is one of a strength factor to which the applicant has particularly paid attention to in recent years.

The gypsum board for structure (GB-St) is a gypsum-based board whose overall strength as a bearing board is improved compared with a (regular) gypsum board (GB-R), and whose lateral nail resistance is improved compared with a reinforced gypsum board (GB-F). Currently, the gypsum board for structure is defined in JIS A 6901 as a gypsum-based board having a lateral nail resistance of 750 N or greater (type A) or 500 N or greater (type B). A wooden load-bearing wall using the gypsum board for structure as a bearing board achieves a relatively high coefficient of effective wall length compared with a wooden load-bearing wall using a (regular) gypsum board or a reinforced gypsum board as a bearing board. Like the reinforced gypsum board, the gypsum board for structure needs to have a thickness of 12.5 mm or greater and a specific gravity of 0.75 or greater. Thus, a wooden load-bearing wall to which the gypsum board for structure is fixed needs to have an area density of a weight per unit area of at least approximately 9.4 kg/m² (a mass of the bearing board per unit area of the wall surface (referred to as an “area density” hereinafter)).

Patent Document 3 (Japanese Patent No. 7012405) discloses a gypsum-based load-bearing bearing board that imparts the same level of the short-term reference shear strength (P0) as the gypsum board for structure, but reduces an area density thereof as compared with the gypsum board for structure. The gypsum-based board disclosed in Patent Document 3 includes a main material or core material, and a paper member covering at least front and back surfaces of the main material or core material. The main material or core material is formed of a board-shaped hardened gypsum in which inorganic fibers and an organic strength improver are added to achieve a lateral nail resistance of 500 N or greater. In addition, the gypsum-based board disclosed in Patent Document 3 has an area density in the range of from 6.5 kg/m² to 8.9 kg/m². The gypsum-based board of Patent Document 3 can impart a relatively high coefficient of effective wall length to a bearing wall even though the gypsum-based board has a thickness of less than 12 mm. The gypsum-based board is a bearing board (referred to as “low-density gypsum-based load-bearing bearing board” hereinafter) developed for inhibiting reduction in a yield strength with a relatively high lateral nail resistance, while reducing an area density compared with a gypsum-based load-bearing bearing board of the related art, such as a gypsum board for structure, to reduce a weight of the board. With this low-density gypsum-based load-bearing bearing board, an ultimate displacement of a bearing wall can be increased to increase a ductility factor of the bearing wall, thereby increasing a coefficient of effective wall length of the bearing wall. Therefore, a gypsum-based load-bearing bearing board very advantageous in practical use can be provided from the viewpoint of achieving all of desired strength as a wooden load-bearing wall, a light weight thereof, constructability, and the like.

In the present embodiment, the term “gypsum-based load-bearing bearing board” is described as a term that encompasses, not only a (regular) gypsum board, a reinforced gypsum board, and a gypsum board for structure specified in JIS A 6901 (Gypsum boards), but also the low-density gypsum-based load-bearing bearing board (Patent Document 3), and a gypsum-based board obtained by covering outer surfaces or outer layers of a gypsum core (core material portion) including gypsum as a main material with a paper member, such as a base paper for a gypsum board, such as the gypsum-based load-bearing bearing board disclosed in Japanese Patent No. 6412431 (Patent Document 4).

### PRIOR ART DOCUMENTS

### Patent Documents

Patent Document 1: International Publication No. WO2019/203148A1
Patent Document 2: Japanese Patent No. 5642948
Patent Document 3: Japanese Patent No. 7012405
Patent Document 4: Japanese Patent No. 6412431

### Non-Patent Document

Non-Patent Document 1: Allowable stress design of houses constructed by a wooden framework construction system [1] (2017 edition), p. 63 and p. 300

### SUMMARY OF THE INVENTION

### Problems to be Solved by the Invention

The present inventors have repeatedly conducted the above performance tests to further increase a coefficient of effective wall length of a bearing wall using the low-density gypsum-based load-bearing bearing board proposed in Patent Document 3, and as a result, the present inventors have recognized that the coefficient of effective wall length can be further increased by preventing phenomena such as a punch-out fracture, edge breakage, and the like due to a punching shear phenomenon. It is considered that breakage, rupture, or the like of a nailed portion, such as a punch-out fracture, can be prevented by providing a reinforcement material or stiffener, such as a metal plate, to a portion to be nailed, as in the board reinforcement method disclosed in Patent Document 1.

As described above, in the case where a step of additionally attaching such a reinforcement material or stiffener to a surface of a bearing board is added to a board production process, or such a step is additionally performed during construction of a wooden load-bearing wall, it is assumed that a production process of a gypsum-based board becomes complicated, or workability of construction work may be impaired.

The present disclosure has been made in view of the above circumstances, and an object thereof is to provide a wooden load-bearing wall using a low-density gypsum-based load-bearing bearing board that has increased lateral nail resistance thereof and has reduced area density thereof, and a construction method, a method of increasing a coefficient of effective wall length of the wooden load-bearing wall, and the gypsum-based load-bearing bearing board, which can inhibit a punching shear phenomenon or minimize an action of a punch-out fracture, thereby inhibiting breakage, rupture, or the like of a nailed portion to further increase a coefficient of effective wall length, without additionally providing a reinforcement material or a stiffener, such as a metal plate.

### Means for Solving the Problems

To achieve the above object, the present disclosure provides a wooden load-bearing wall. The wooden load-bearing wall includes a gypsum-based load-bearing bearing board that is fastened onto a wooden structure wall base of a wooden framework construction system or a wood framing construction system with fasteners. The gypsum-based load-bearing bearing board includes a main material or core material formed of a board-shaped hardened gypsum, and a paper member covering at least front and back surfaces of the main material or core material. An area density or a weight per unit area of the gypsum-based load-bearing bearing board is in a range of from 6.5 kg/m² to 8.9 kg/m². The area density or the weight per unit area of the gypsum-based load-bearing bearing board is determined as a mass per unit area of a wall surface. The bearing board has a lateral nail resistance of 500 N or greater, and a compressive strength of at least 6.5 N/mm² or greater. Each of the fastener is a metal nail a head portion and a body portion, where an area ratio of an area of the head portion to a cross-sectional area of the body portion is set at a value within a range of from 6 to 13. The bearing wall has a value of a ultimate displacement (δu) that is greater than 20×10⁻³ rad. The ultimate displacement is an ultimate displacement determined by measuring a bearing wall test sample having a length of 1.82 m according to an in-plane shear test.

Moreover, the present disclosure provides a method of constructing a wooden load-bearing wall. The method includes fastening a gypsum-based load-bearing bearing board onto a wooden structure wall base of a wooden framework construction system or a wood framing construction system with fasteners. The gypsum-based load-bearing bearing board includes a main material or core material formed of a board-shaped hardened gypsum, and a paper member covering at least front and back surfaces of the main material or core material. An area density or a weight per unit area of the gypsum-based load-bearing bearing board is in a range of from 6.5 kg/m² to 8.9 kg/m². The area density or the weight per unit area of the gypsum-based load-bearing bearing board is determined as a mass per unit area of a wall surface. The gypsum-based load-bearing bearing board has a lateral nail resistance of 500 N or greater, and a compressive strength of at least 6.5 N/mm² or greater. Each of the fasteners is a metal nail having a head portion and a body portion, where an area ratio of an area of the head portion to a cross-sectional area of the body portion is set at a value within a range of from 6 to 13. The wooden load-bearing wall has a value of a ultimate displacement (δu) that is greater than 20×10⁻³ rad. The ultimate displacement is an ultimate displacement determined by measuring a bearing wall test sample having a wall length of 1.82 m according to an in-plane shear test.

Preferably, the nail has a head diameter in the range of from 6.0 mm to 10.0 mm and a body diameter in the range of from 2.0 mm to 5.0 mm. More preferably, the nail has the head diameter in the range of from 6.8 mm to 9.0 mm and the body diameter in the range of from 2.2 mm to 4.2 mm, and an area ratio of an area of the head portion to a cross-sectional area of the body portion (referred to as an “area ratio of the head area to the body cross-sectional area” hereinafter) is set at a value within the range of from 7 to 11. Preferably the body portion of the nail is a body portion of a straight and smooth shape having a uniform circular cross-sectional surface, and the body portion has a pointed tip. The head portion of the nail is a head portion having a flat head shape or a meshed flat head shape and having a circular contour in a top view. The head portion has a circular and flat bearing surface that is borne on an outer surface of the gypsum-based load-bearing bearing board by nailing, and a flat top surface that is designed to be positioned substantially in the same plane as the wall surface constituted by an outer surface of the gypsum-based load-bearing bearing board after nailing.

Inorganic fibers and an organic strength improver are preferably added to the main material or the core material in the gypsum-based load-bearing bearing board so that, while the minimum physical property (lateral nail resistance: 500 N or greater) as the gypsum-based load-bearing bearing board is secured, the area density of the board is surprisingly reduced and is set at a relatively low value (6.5 kg/m² to 8.9 kg/m²). For example, the amount of the inorganic fibers is from 0.3 parts by weight to 5 parts by weight, and preferably from 2 parts by weight to 4 parts by weight, relative to 100 parts by weight of calcined gypsum. Examples of the inorganic fibers to be added include glass fibers, carbon fibers, and the like. In the case where the glass fibers are used, glass fibers each having a diameter of from 5 μm to 25 μm and a length of from 2 mm to 25 mm can be suitably used. The amount of the organic strength improver is from 0.3 parts by weight to 15 parts by weight, and preferably from 1 part by weight to 13 parts by weight, relative to 100 parts by weight of the calcined gypsum. As the organic strength improver, for example, starches, polyvinyl acetate, polyvinyl alcohol, polyacrylics, or the like can be suitably used. As the starch, either an unprocessed starch or a processed starch can be used. Examples of the processed starch include starches processed by a physical treatment, a chemical treatment, or an enzymatic treatment. As the starch processed by the physical treatment, pregelatinized starch can be suitably used. As the starch processed by the chemical treatment, oxidized starch, phosphate starch, urea phosphate esterified starch, hydroxypropyl distarch phosphate, hydroxyethylated starch, hydroxypropylated starch, cationic starch, or acetylated starch can be suitably used.

In the description of the present specification, the phrase “the minimum physical property as the gypsum-based load-bearing bearing board” means a lateral nail resistance of 500 N or greater. Moreover, known factors for varying a compressive strength of the gypsum-based load-bearing bearing board are a kneading state of gypsum slurry (kneading time, kneading temperature, etc.), kinds and amount of impurities contained in a gypsum raw material, cross-sectional characteristics of the gypsum core, density and uniformity, an amount, size, and dispersed state of air bubbles included in the gypsum core, a water content of the gypsum core, a specific gravity of the gypsum core, and the like. These factors may be used as control factors for increasing or decreasing a compressive strength, but are control factors closely associated with production conditions (a kind of a gypsum raw material, kinds and amounts of additives, such as a foaming agent, and the like, a temperature of kneading water, a temperature and humidity, and the like), and are also related to an overall quality of the gypsum core. Therefore, these factors are not control factors of characteristics that can be used exclusively for a specific application for imparting a desired compression strength (compressive strength of 6.5 N/mm² or greater) to a gypsum-based load-bearing bearing board and impairing a desired lateral nail resistance (nail resistance of 500 N or greater) to the gypsum-based load-bearing bearing board in cooperation with inorganic fibers, at a relatively low area density (area density in the range of from 6.5 kg/m² to 8.9 kg/m²). Meanwhile, the organic strength improver can be exclusively used for such application, and can be simply added to gypsum slurry during a production process. Therefore, use of the organic strength improver can provide a realistic and effective method for increasing a compressive strength of the gypsum core.

The value (6.5 kg/m² to 8.9 kg/m²) of an area density of the gypsum-based load-bearing bearing board according to the present disclosure is a significantly smaller value than an area density (approximately 9.4 kg/m²) of a gypsum-based load-bearing bearing board of the related art, such as a gypsum board for structure. Owing to the above area density, the specific gravity, thickness, or both of the gypsum-based load-bearing bearing board is reduced, thereby reducing a weight or thickness of a bearing wall. The reduction in the area density is a condition contrary to a method of increasing a coefficient of effective wall length according to the related art, in which a short-term reference shear strength (P0) and a coefficient of effective wall length of a bearing wall are increased (i.e., a method of increasing a coefficient of effective wall length of a related art in which a maximum strength (Pmax) is increased by increasing a specific gravity, plate thickness, or both, thereby increasing a short-term reference shear strength (P0)). However, as described in Patent Document 3, when an area density is reduced, while maintaining the minimum physical property (lateral nail resistance: 500 N or greater) as the gypsum-based load-bearing bearing board, the toughness and shape conformability upon deformation intrinsically possessed by the gypsum-based load-bearing bearing board are manifested in the ductile region, and as a result, the ultimate displacement (δu) and ductility factor (μ) of the bearing wall increase. Thus, the ultimate strength (corrected value) (Pu′) of the bearing wall increases so that the short-term reference shear strength (P0) and the coefficient of effective wall length can be increased without necessarily increasing the maximum strength (Pmax).

Further, the present inventors have found through many experiments that an initial stiffness (K) of a bearing wall is increased by increasing a compressive strength of a gypsum-based load-bearing bearing board. Based on this insight, the present inventors intensively conducted research, and as a result, have found that a compressive strength of the gypsum-based load-bearing bearing board is increased to a value of 6.5 N/mm² or greater to increase an initial stiffness (K) of a bearing wall, thereby reducing a yield point displacement (δv) without significantly reducing an ultimate displacement (δu) of the bearing wall, and as a result, a ductility factor (μ) can be significantly increased.

Specifically, according to the present disclosure, the compressive strength of the gypsum-based load-bearing bearing board is increased to a value of 6.5 N/mm² or greater to increase an initial stiffness (K) of the bearing wall to a value of 2.0 kN/10⁻³ rad or greater, thereby reducing a value of a yield point displacement (δv) to be 7.2×10⁻³ rad or less, so that a value of a ductility factor (μ) can be significantly increased interdependently with a relatively high value of the ultimate displacement (δu), and as a result, as an ultimate strength correction value (Pu′), for example, a value of 7.7 kN or greater, is relatively easily secured.

The bearing wall using the low-density gypsum-based load-bearing bearing board of Patent Document 3 has a value of an initial stiffness (K) that is less than 2.0 kN/10⁻³ rad (e.g., 1.9 kN/10⁻³ rad). Note that, the above-described gypsum board for structure is a gypsum-based load-bearing bearing board that is developed for desirably increasing a lateral nail resistance considering a load bearing factor of a lateral nail resistance for inhibiting a tensile fracture of the gypsum-based load-bearing bearing board due to a change in relative positions during vibrations. The low-density gypsum-based load-bearing bearing board of Patent Document 3 is designed for manifesting toughness of the gypsum-based load-bearing bearing board and shape conformability thereof upon deformation in the ductile region by reducing an area density while maintaining a desired lateral nail resistance, thereby increasing a ductility factor (μ) and ultimate strength (corrected value) (Pu′). Neither focused on nor considered a compressive strength of the gypsum-based load-bearing bearing board or the initial stiffness caused in the elastic region as factors for improving load bearing, and did not examine nor research the structural relationship between the initial stiffness of the bearing wall and the compressive strength of the gypsum-based load-bearing bearing board.

According to the experiments conducted by the present inventors, the compressive strength is desirably increased by increasing the area density, but as the area density increases, the ultimate displacement tends to decrease in addition to increase in weight of the board. Therefore, the compressive strength is desirably increased to an appropriate value using mainly an action of an organic strength improver or the like to increase the compressive strength. Specifically, in the present disclosure, the compressive strength is desirably set mainly by setting an appropriate area density and an action of increasing a compressive strength through addition of an organic strength improver or the like.

Preferably, the compressive strength is 7.5 N/mm² or greater so as to secure a value of 7.2×10⁻³ rad or less as a yield point displacement (δv) of the bearing wall measured by the in-plane shear test, or secure a value of 2.2 kN/10⁻³ rad or greater as the initial stiffness (K) and a value of 7.2×10⁻³ rad or less as the yield point displacement (δv). For example, assuming that a yield point displacement (δv) is 6.0×10⁻³ rad, an initial stiffness (K) is 2.5 kN/10⁻³ rad, an ultimate strength Pu is 15.0 kN, an ultimate displacement (δu) is 30×10⁻³ rad, a ductility factor (μ) is 5.0, and a coefficient of variation β is 1.0 in the gypsum-based load-bearing bearing board according to the present disclosure, the ultimate strength (corrected value) (Pu′) is 9.0 kN. Similar to the above-described low-density gypsum-based load-bearing bearing board (Patent Document 3), in the case where the initial stiffness (K) is set at 1.9 kN/10⁻³ rad (<2.0 kN/10⁻³ rad), even if the ultimate strength Pu is 15.0, the ultimate displacement (δu) is 30×10⁻³ rad, and the coefficient of variation β is 1.0, the yield point displacement (δv) is 7.8×10⁻³ rad, the ductility factor (μ) is 3.8, and the ultimate strength (corrected value) (Pu′) is only approximately 7.7 kN. Specifically, by increasing the compressive strength of the bearing board to increase the initial stiffness (K), the ultimate strength (corrected value) (Pu′) is relatively significantly increased so that the short-term reference shear strength (P0) and the coefficient of effective wall length are relatively significantly increased.

In the present disclosure, the compressive strength can be preferably set at a value in the range of from 7.5 N/mm² to 13.0 N/mm², and more preferably at a value of 8.0 N/mm² or greater. Moreover, in the present disclosure, the initial stiffness can be preferably set at a value in the range of 2.2 kN/10⁻³ rad to 4.0 kN/10⁻³ rad, and more preferably at a value of 2.4 kN/10⁻³ rad or greater. Further, in the present disclosure, the yield point displacement (δv) can be preferably set at a value in the range of from 3.5×10⁻³ rad to 7.2×10⁻³ rad, and more preferably a value of 6.5×10⁻³ rad or less.

According to the bearing wall including the gypsum-based load-bearing bearing board according to the preferred embodiment of the present disclosure, as a ductility factor (μ) measured by the in-plane shear test, a value of 4.2 or greater and 10.0 or less, and preferably a value of 4.3 or greater is obtained, and as a yield strength (Py) measured by the in-plane shear test, a value of 7.7 kN or greater and greater than ultimate strength (corrected value) (Pu′), and preferably a value of 8.0 kN or greater are obtained. According to the experiments conducted by the present inventors, a yield strength (Py) tends to increase, as the initial stiffness (K) is increased, and therefore it has been found that the yield strength (Py) is generally greater than the ultimate strength (corrected value) (Pu′), similar to the above-described low-density gypsum-based load-bearing bearing board (Patent Document 3).

Therefore, the gypsum-based load-bearing bearing board of the present disclosure improves toughness and shape conformability upon deformation in the ductile region to increase the ultimate strength (corrected value) (Pu′) by reducing the area density, while the minimum physical property as the gypsum-based load-bearing bearing board, and also further increases the ultimate strength (corrected value) (Pu′) through increase in the initial stiffness (K) and the reduction in the yield point displacement (δv). Thus, the short-term reference shear strength (P0) and the coefficient of effective wall length of the wooden load-bearing wall can be relatively significantly increased without additionally attaching a reinforcement material or a stiffener, such as a metal plate or the like, and without increasing the area density of the gypsum-based load-bearing bearing board. According to the present disclosure, moreover, a metal nail in which an area ratio of a head area to a body cross-sectional area is set at a value within the range of from 6 to 13 is used as a fastener for fastening the above gypsum-based load-bearing bearing board on the wooden structure wall base. Thus, a punch-out fracture can be effectively inhibited or an action thereof can be minimized without additionally attaching or providing a reinforcement material or a stiffener, such as a metal plate or the like, so that the short-term reference shear strength (P0) and coefficient of effective wall length of the wooden load-bearing wall can be effectively or efficiently increased interdependently with the above function of the gypsum-based load-bearing bearing board. Further, similar to the gypsum board for structure or the above-described low-density gypsum-based load-bearing bearing board (Patent Document 3), at least front and back surfaces of a main material or core material of the above gypsum-based load-bearing bearing board are covered with a paper member, the bearing board can be easily produced in an existing gypsum board production line. Preferably, the gypsum-based load-bearing bearing board of the present disclosure includes a laminate structure in which a surface or a surface layer of a core material is covered with base paper for a gypsum board. Note that, the “front and back surfaces” means a front surface and back surface of the board excluding end edges and side edges (i.e., four peripheral outer edge portions) of the board.

The thickness of the gypsum-based load-bearing bearing board is preferably set at a value of 7.5 mm or greater and less than 12 mm (more preferably a value of 8.5 mm or greater and 10 mm or less), for example, 9.5 mm or 9.0 mm. The gypsum-based load-bearing bearing board having the above thickness is advantageous in terms of reduction in thickness of a wooden load-bearing wall, compared to a gypsum board for structure having a thickness of 12 mm or greater. Optionally, the hardened gypsum has the lateral nail resistance of 980 N or less.

Preferably, the gypsum-based load-bearing bearing board exhibits an ultimate displacement (δu) of 24×10⁻³ rad or greater (preferably 26×10⁻³ rad or greater) in the bearing wall, where the ultimate displacement (δu) is an ultimate displacement (δu) of the bearing wall determined by measuring a bearing wall test sample having a length of 1.82 m according to an in-plane shear test. The value of ultimate displacement (δu), which is set at a relatively high value, can relatively significantly increase a value of a ductility factor (μ) interdependently with increase in the initial stiffness (K) of the bearing wall and reduction in the yield point displacement (δv) so that it is extremely effective for increasing a short-term reference shear strength (P0) and coefficient of effective wall length. Note that, the ultimate displacement (δu) of the bearing wall is an index for indicating the toughness of the bearing wall and shape conformability thereof upon deformation in the ductile region. According to the “Wooden bearing walls and operational procedures of testing and evaluating magnifications and performance thereof,” in the case where a load does not decrease even at 1/15 rad in the in-plane shear test and a value of the ultimate displacement cannot be obtained, the ultimate displacement (δu) is set at 1/15 rad. Accordingly, the maximum value of the ultimate displacement (δu) is 1/15 rad (66.7×10⁻³ rad).

Preferably, a specific gravity of the gypsum-based load-bearing bearing board is set at a value in the range of from 0.65 to 0.96, and preferably at a value in the range of from 0.7 to 0.9 (more preferably a value in the range of from 0.7 to 0.8). The gypsum-based load-bearing bearing board having the above specific gravity is advantageous because the weight thereof can be reduced, compared with, for example, an actual product of a gypsum-based board of Patent Document 4, which has a thickness of, for example, less than 12 mm, but a specific gravity of 1.0 or greater (e.g., “EX board” (product name), produced by YOSHINO GYPSUM CO., LTD.), so that a weight of a wooden load-bearing wall can be reduced, or constructability of a wooden load-bearing wall, workability of construction works, or the like can be improved.

In the preferred embodiment of the present disclosure, moreover, the core material (gypsum core portion) of the gypsum-based load-bearing bearing board includes an organopolysiloxane compound as a strength deterioration inhibitor mainly for inhibiting strength deterioration. According to the above gypsum-based load-bearing bearing board, the bearing board that can be constructed as an outer wall surface of a wooden exterior wall can be provided, similar to the gypsum-based load-bearing bearing board disclosed in Patent Document 4.

From another viewpoint, the present disclosure provides a method of increasing a coefficient of effective wall length of a wooden load-bearing wall that is constructed by fastening a gypsum-based load-bearing bearing board onto a wooden structure wall base of a wooden framework construction system or a wood framing construction system with fasteners. The bearing board includes a main material or core material formed of a board-shaped hardened gypsum, and a paper member covering at least front and back surfaces of the main material or core material. The method includes setting a composition of the hardened gypsum of the main material or the core material so that an area density or a weight per unit area of the bearing board, which is determined as a mass per unit area of a wall surface, is reduced down to the range of from 6.5 kg/m² to 8.9 kg/m², and the bearing board has a lateral nail resistance of 500 N or greater and a compressive strength of 6.5 N/mm² or greater. As each of the fasteners, a metal nail, in which an area ratio of an area of a head portion to a cross-sectional area of a body portion is set at a value within the range of from 6 to 13, is used to inhibit a punching shear phenomenon or minimize an action of a punch-out fracture. As an ultimate displacement (δu) of the wooden load-bearing wall determined by measuring a bearing wall test sample having a length of 1.82 m according to an in-plane shear test, a value of the ultimate displacement that is greater than 20×10⁻³ rad is obtained.

According to the above method of increasing the coefficient of effective wall length, the area density of the gypsum-based load-bearing bearing board is reduced by reducing a specific gravity, a thickness, or both, thereby reducing a weight or thickness of the wooden load-bearing wall. According to the method of increasing the coefficient of effective wall length, as described above, toughness of the gypsum-based load-bearing bearing board (in a ductile region) and shape conformability thereof upon deformation are improved by reduction in density of the gypsum-based load-bearing bearing board so that a value of an ultimate displacement (δu) is increased, and an initial stiffness (K) of the wooden load-bearing wall is also increased by increase in compressive strength of the gypsum-based load-bearing bearing board, thereby reducing a value of a yield point displacement (δv). As a result, a value of a ductility factor (μ=δu/δv) is relatively significantly increased due to a synergetic effect between the relatively small yield point displacement (δv) and the relatively large ultimate displacement (δu) so that, as an ultimate strength (corrected value) (Pu′) of the wooden load-bearing wall, a value of 7.7 kN or greater is relatively easily obtained.

The present disclosure further provides a gypsum-based load-bearing bearing board used in the above-described method of constructing the wooden load-bearing wall or the method for increasing the coefficient of effective wall length, and is fastened onto a wooden structure wall base of a wooden framework construction system or a wood framing construction system with fasteners. The gypsum-based load-bearing bearing board has a lateral nail resistance of 500 N or greater, in addition to a compressive strength of at least 6.5 N/mm² or greater. The gypsum-based load-bearing bearing board has an area density or a weight per unit area within a range of from 6.5 kg/m² to 8.9 kg/m². In cooperation with the fasteners, an ultimate displacement (δu) of the bearing wall determined by measuring a bearing wall test sample having a wall length of 1.82 m according to an in-plane shear test is increased to a value that is greater than 20×10⁻³ rad.

### Effects of the Invention

According to the gypsum-based load-bearing bearing board of the present disclosure, toughness of a bearing wall and shape conformability thereof upon deformation can be improved using a low-density gypsum-based load-bearing bearing board whose area density is reduced. An initial stiffness (K) of the bearing wall, in which the bearing board is fastened onto a wooden structure wall base with fasteners, is increased to reduce a yield point displacement (δv), thereby increasing a ductility factor (μ=δu/δv) so that a short-term reference shear strength (P0) and a coefficient of effective wall length can be increased. The gypsum-based load-bearing bearing board according to the present disclosure is used for a bearing wall whose ultimate displacement (δu) is not easily increased, or a bearing wall having a value of ultimate displacement (δu) that is close to the maximum value, and can be effectively used as a bearing board that can further increase a short-term reference shear strength (P0) and a coefficient of effective wall length without causing increase in a wall thickness, increase in weight of wall, or the like. In addition, since at least front and back surfaces of a main material or core material is covered with a paper member, the gypsum-based load-bearing bearing board of the present disclosure can be easily produced in an existing gypsum board production line.

According to the wooden load-bearing wall of the present disclosure including the above gypsum-based load-bearing bearing board and a method of constructing the wooden load-bearing wall, and a method of increasing a coefficient of effective wall length of the wooden load-bearing wall in which the above gypsum-based load-bearing bearing board is fastened onto a wooden structure wall base of to a wooden framework construction system or a wood framing construction system with fasteners, metal nails having specific dimensions and shapes (head diameter D, body diameter d, and ratio η of head area/body cross-sectional area) are used as the fasteners, so that a punch-out fracture of the gypsum-based load-bearing bearing board is effectively inhibited or an action thereof is minimized, thereby significantly improving a short-term allowable shear strength (Pa) and a coefficient of effective wall length. Specifically, according to the present disclosure, the wooden load-bearing wall, the method of constructing the wooden load-bearing wall, and the method of increasing the coefficient of effective wall length of the wooden load-bearing wall can further increase a short-term reference shear strength bearing wall (P0) and a coefficient of effective wall length of the wooden load-bearing wall without additionally attaching a reinforcement material or a stiffener, such as a metal plate or the like, without increasing an area density (specific gravity, thickness, or both) of the gypsum-based load-bearing bearing board (i.e., without increasing a weight, thickness, or both of the wooden load-bearing wall), and without further increasing a value of an ultimate displacement (δu).

According to a bearing wall structure of a wooden structure building according to the present disclosure, a construction method thereof, or a method of constructing a bearing wall, moreover, the above gypsum-based load-bearing bearing board is used as a bearing board for a wooden load-bearing wall so that an area density of the gypsum-based load-bearing bearing board is reduced without reducing a short-term reference shear strength (P0) and a coefficient of effective wall length (or effectively increasing the coefficient of effective wall length), thereby reducing a weight or thickness of the wooden load-bearing wall or improving constructability or the like of the wooden load-bearing wall.

According to the bearing wall structure of the wooden structure building according to the present disclosure, the construction method thereof, or the method of increasing the coefficient of effective wall length, furthermore, an initial stiffness (K) is increased to reduce a yield point displacement (δv), thereby increasing an ultimate strength (corrected value) (Pu′) and increasing a short-term reference shear strength (P0) and a coefficient of effective wall length. Therefore, the coefficient of effective wall length can be increased without depending on reinforcement or stiffening achieved by a reinforcement material or a stiffener, such as a metal plate or the like, additionally provided to the gypsum-based board, without depending on increase in specific gravity, thickness, or both of the gypsum-based board, and without largely depending on increase in a value of the ultimate displacement (δu).

### BRIEF DESCRIPTION OF THE DRAWINGS

FIG. 1 is a front view schematically illustrating an embodiment of a bearing wall of a wooden structure building according to the present disclosure.

FIG. 2 is a cross-sectional partial view and a partial perspective cutaway view of an enlarged portion of the bearing wall illustrating the portion where the gypsum-based load-bearing bearing board is fixed on the wooden structure framework with nails.

FIG. 3 is a front view, a lateral cross-sectional view, and a side view illustrating a structure of a bearing wall test sample used for an in-plane shear test of the bearing wall structure illustrated in FIG. 1.

FIG. 4 is a graph illustrating, as a reference, an envelope (indicated with a solid line) of a load-deformation angle curve obtained by an in-plane shear test of an arbitrary wooden load-bearing wall, and a graph depicting a line graph obtained by converting the envelop of the load-deformation angle curve into load-deformation angle characteristics of a perfect elastoplastic model with a dot-dash line.

FIG. 5 is a table illustrating a head diameter, a body diameter, and a ratio of a head area to a body cross-sectional area of the nails used to constitute the bearing wall according to an example of the present disclosure, and two types of nails that have been used in the related art for fastening a gypsum-based load-bearing bearing board onto a framework or frame of a wooden structure.

FIG. 6 is a table and a line graph illustrating, in comparison, test results of the in-plane test for wood structure bearing walls using two types of nails (Comparative Examples 1 and 2) of the related art presented in FIG. 5.

FIG. 7 is a table and a line graph illustrating, in comparison, test results of the in-plane test for a wood structure bearing wall using the nail (Comparative Example 3) of the related art presented in FIG. 5, and a wood structure bearing wall using the nail of the present example presented in FIG. 5.

FIG. 8 is a table presenting, as well as physical properties, compositions, and load-bearing test results of the gypsum-based load-bearing bearing board constituting the present disclosure as Reference Examples 1 to 4, presenting physical properties, composition, and load-bearing test results of the gypsum-based load-bearing bearing board according to Comparative Example 4.

FIG. 9 is a diagram illustrating a test result of the in-plane shear test of the bearing wall structure of Reference Examples 1 to 4 and Comparative Examples 4, as load-deformation angle characteristics of a perfect elastoplastic model.

FIG. 10 is a partial front view of a compressive strength test device conceptually illustrating a compressive strength measuring method for measuring a compressive strength of the gypsum-based load-bearing bearing board.

### DETAILED DESCRIPTION OF THE INVENTION

A structure of the wooden load-bearing wall according to a preferred embodiment of the present disclosure will be described in detail with reference to the accompanying drawings.

### [Overall Structure of Wooden Load-Bearing Wall]

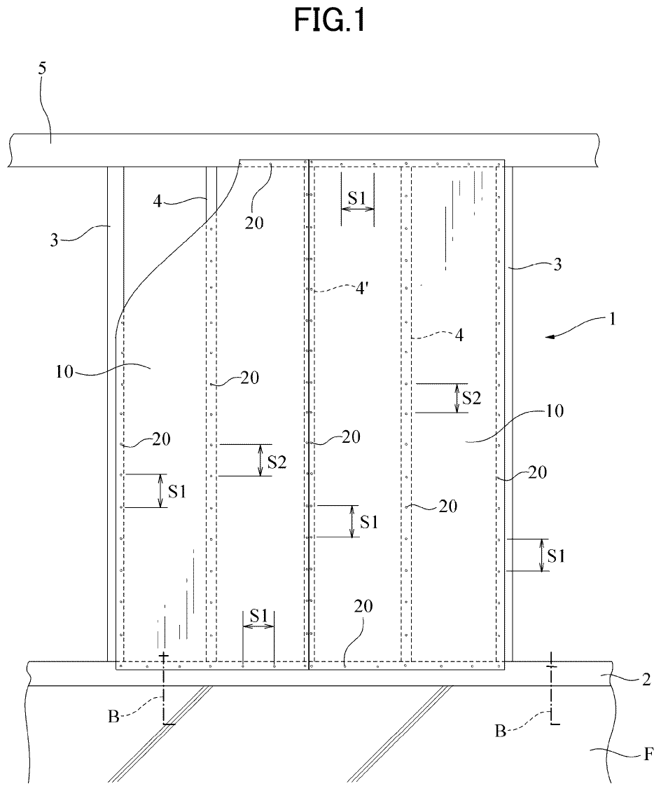

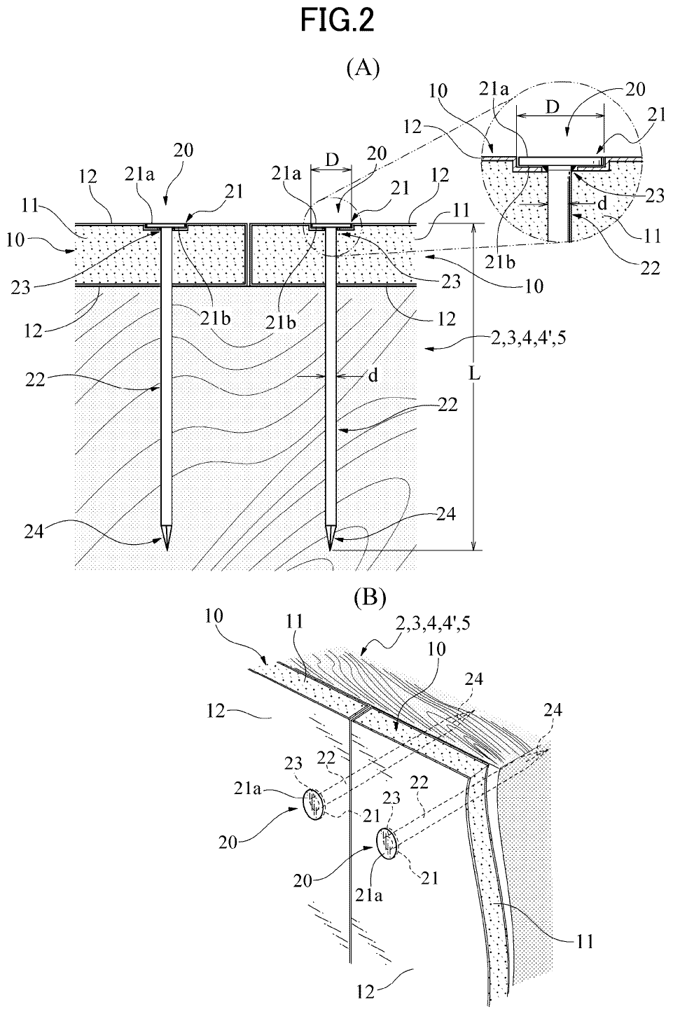

FIG. 1 is a front view schematically illustrating a structure of a bearing wall of a wooden structure building according to the preferred embodiment of the present disclosure. Moreover, (A) and (B) of FIG. 2 are each related to the bearing wall depicted in FIG. 1, and are a cross-sectional partial view and partial perspective cutaway view of an enlarged portion of the bearing wall in which the gypsum-based load-bearing bearing board is fixed on the wooden framework by nails.

The wooden load-bearing wall 1 illustrated in FIG. 1 is a wooden load-bearing wall of a wooden framework construction system constructed by fixing the gypsum-based load-bearing bearing board 10 onto a wooden framework on a continuous footing F of a reinforced concrete (RC) structure. The bearing board 10 has dimensions of 9.5 mm in thickness, 910 mm in width, and approximately 2,800 mm to approximately 3,030 mm (e.g., approximately 2,900 mm) in height, and has an area density in the range of from 6.5 kg/m² to 8.9 kg/m² (e.g., area density of 7.5 kg/m²). The area density (also referred to as a weight per unit area) is a mass (weight) per unit area (projected area) of the wall surface as viewed in a front view of the wall surface. As illustrated in FIG. 2, the bearing board 10 is a gypsum-based load-bearing bearing board including a flat board gypsum core (gypsum core material) 11 to which predetermined amounts of inorganic fibers (glass fibers) and an organic strength improver (starch powder) are added, and base paper (paper member) 12 for a gypsum board, which covers the both surfaces of the gypsum core.

The bearing wall 1 has a sill plate 2 fixed on a top surface of the continuous footing F by anchor bolts B. The bearing wall 1 mainly includes the sill plate 2, posts 3 vertically arranged on the sill plate 2 at predetermined intervals, studs 4 and joint studs 4′, horizontal members (beams, girding beams, pole plates, and end beams) 5 supported by upper ends (or intermediate portions) of the posts 3, and the bearing boards 10. The sill plate 2, the posts 3, the studs 4, the joint studs 4′, and the horizontal members 5 constituting the framework are dressed wood members (squared timber) typically used for wooden buildings.

The bearing board 10 is fixed on the sill plate 2, the post 3, the stud 4, the joint stud 4′, and the horizontal member 5 by iron or stainless steel (iron in the present example) nails 20. The nails 20 are arranged in a four-side peripheral zone of the bearing board 10 with a gap S1 interposed between the adjacent nails 20, and arranged in the central zone of the bearing board 10 extending in the vertical direction with a gap S2 interposed between the adjacent nails 20. Preferably, the gap S1 is set in the range of from 50 mm to 200 mm (e.g., 75 mm), and the gap S2 is set in the range of from 50 mm to 300 mm (e.g., 150 mm).

As illustrated in FIG. 2, the nail 20 is an iron nail including a head portion 21, a body portion 22, a neck portion 23, and a pointed tip 24, where the head portion 21 has a flat head shape or a flat meshed head shape and has a circular contour in a top view, the body portion 22 has a straight and smooth shape and has a uniform circular cross-sectional surface, the neck portion 23 is positioned proximal to an end of the body portion 22, and continuously connected to the body portion 22 and the head portion 21 as a one body, and the tip 24 is positioned at an edge of the body portion 22. The lower surface of the head portion 21 constitutes an annular bearing surface 21b borne on an outer surface of the bearing board 10. Since the outer peripheral portion of the neck portion 23 is locally tapered or conically expanded slightly to be continuous with the head portion 21, the dimension of the bearing surface 21b in the radial direction does not necessarily coincide with the difference in diameter between the head portion 21 and the body portion 22, and is a value slightly smaller than the difference in diameter, but is a value substantially equal to the difference in diameter.

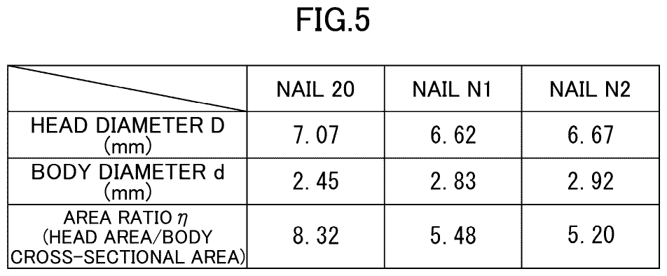

Generally, the nail 20 is defined by, in addition to the material and shapes of the head portion 21 and the body portion 22, a diameter of the head portion 21 (head diameter D), a diameter of the body portion 22 (body diameter d), a total length of the nail 20 (length L), and the like. In the present embodiment, the head diameter D, the body diameter d, and the length L are 7.07 mm, 2.45 mm, and approximately 50 mm, respectively, and a ratio η of a projected area of the top surface 21a of the head portion 21 to an area of the lateral cross-sectional surface of the body portion 22 (i.e., head area/body cross-sectional area) is 8.32 (see FIG. 5). In the present disclosure, the head diameter D is preferably at a value within the range of from 6.0 mm to 10.0 mm, and more preferably from 6.8 mm to 9.0 mm. The body diameter d is preferably set at a value within the range of from 2.0 mm to 5.0 mm, and more preferably from 2.2 mm to 4.2 mm. Moreover, the ratio η of the head area to the body cross-sectional area is preferably set at a value within the range of from 6 to 13, and more preferably from 7 to 11.

The gypsum core 11 of the bearing board 10 includes predetermined amounts of inorganic fibers and an organic strength improver, and has a lateral nail resistance of 500 N or greater. The amount of the inorganic fibers is from 0.3 parts by weight to 5 parts by weight, and preferably from 2 parts by weight to 4 parts by weight, relative to 100 parts by weight of calcined gypsum. Examples of the inorganic fibers to be mixed include glass fibers, carbon fibers, and the like. When glass fibers are used, glass fibers each having a diameter of from 5 μm to 25 μm and a length of from 2 mm to 25 mm are suitably used. Moreover, the amount of the organic strength improver is from 0.3 parts by weight to 15 parts by weight, and preferably from 1 part by weight to 13 parts by weight, relative to 100 parts by weight of the calcined gypsum. Examples of the organic strength improver include starches, polyvinyl acetate, polyvinyl alcohol, polyacrylics, and the like. As the starch, either an unprocessed starch or a processed starch can be used. Examples of the processed starch include starches processed by a physical treatment, a chemical treatment, or an enzymatic treatment. As the starch processed by the physical treatment, pregelatinized starch can be suitably used. As the starch processed by the chemical treatment, oxidized starch, phosphate starch, urea phosphate esterified starch, hydroxypropyl distarch phosphate, hydroxyethylated starch, hydroxypropylated starch, cationic starch, or acetylated starch can be suitably used. The addition of the organic strength improver is an effective measure for imparting a desired compressive strength (compressive strength of 6.5 N/mm² or greater) to the bearing board 10, while securing a relative low area density (area density within the range of from 6.5 kg/m² to 8.9 kg/m²), and achieving or securing a desired lateral nail resistance (lateral nail resistance of 500 N or greater) in cooperation with the inorganic fibers. Considering a point such that the addition of the organic strength improver does not largely affect an overall quality of the gypsum-based load-bearing bearing board, moreover, the addition of the organic strength improver is a simple and realistically or practically effective measure for improving the lateral nail resistance of the bearing board 10.

The composition and structure of the bearing board 10 are similar to a composition and structure of the “gypsum board for structure” specified in JIS A 6901. However, the area density of the bearing board 10 is a value within the range of from 6.5 kg/m² to 8.9 kg/m² (e.g., 7.5 kg/m²). Accordingly, the bearing board 10 is fundamentally different from the “gypsum board for structure” of JIS A 6901, which requires the area density of 9.4 kg/m² or greater as described above. Moreover, the “reinforced gypsum board” specified in JIS A 6901 has been known. The “reinforced gypsum board” also requires the area density of 9.4 kg/m² or greater, and therefore the bearing board 10 is also fundamentally different from the “reinforced gypsum board.” Moreover, the bearing board 10 is different from other “gypsum boards” in that the bearing board 10 includes the main material or core material (gypsum core 11) to which the inorganic fibers and the organic strength improvers are added to achieve the lateral nail resistance of 500 N or greater. Specifically, the bearing board 10 does not correspond to any of “gypsum boards” specified in current JIS A 6901. In this sense, the bearing board 10 is specified or described as a “gypsum-based load-bearing bearing board” in the present specification.

Generally, a gypsum-based load-bearing bearing board (including a “gypsum board,” a “reinforced gypsum board,” and “gypsum board for structure”) including a board-shaped main material or core material formed of a hardened gypsum and a paper member covering front and back surfaces of the main material or core material is produced by a general-purpose gypsum board production device. As described in International Publication No. WO2019/058936, for example, the gypsum board production device includes a mixer that mixes raw materials, such as calcined gypsum, an adhesive aid, a hardening accelerator, air bubbles (or a foaming agent), and the like, and kneading water used to form slurry of the calcined gypsum to prepare gypsum slurry. The gypsum slurry is spread over gypsum board base paper (bottom paper) on a conveyor belt of the gypsum board production device, and gypsum board base paper (top paper) is stacked on the gypsum slurry. The formed continuous stack having a band-like three layer structure is processed by various devices, such as a rough cutting device, a forced drying device, a cutting device, and the like, constituting the gypsum board production device, to thereby form a gypsum product having predetermined dimensions, i.e., a gypsum-based board in which both surfaces of the hardened product of the gypsum slurry (i.e., the gypsum core) is covered with base paper for a gypsum board. The specific gravity of the gypsum-based board is mainly adjusted by an amount of the air bubbles in the gypsum slurry.

Regarding wooden load-bearing walls, respectively using the gypsum board for structure, reinforced gypsum board, and (regular) gypsum board specified in JIS A 6901 as a bearing board, values of the coefficient of effective wall length of the board bearing walls for large wall construction (wall having embedded posts) of a wooden framework structure specified in the above-described Notification No. 1100 of the Ministry of Construction are exemplified as follows.
Gypsum board for structure (type A): 1.7
Gypsum board for structure (type B): 1.2
Reinforced gypsum board: 0.9
(Regular) gypsum board: 0.9

Moreover, the coefficient of effective wall length for bearing walls of a two by four system (bearing walls having a vertical frame spacing of greater than 50 cm) specified in the above-described Notification No. 1541 of the Ministry of Land, Infrastructure, Transport, and Tourism are exemplified as follows.
Gypsum board for structure (type A): 1.7
Gypsum board for structure (type B): 1.5
Reinforced gypsum board: 1.3
(Regular) gypsum board: 1.0

As listed above, the values of the coefficient of effective wall length specified in the notifications of the Ministry of Construction or the Ministry of Land, Infrastructure, Transport, and Tourism are values that can be adapted without individually performing a performance test. However, the gypsum board for structure, the reinforced gypsum board, and the (regular) gypsum board, which have been recognized as being effective as a bearing board, are limited to those having a thickness of 12 mm or greater. In the case where a board of a novel material or composition or a gypsum-based board having a thickness of less than 12 mm is effectively used as a bearing board, or a value of a coefficient of effective wall length, which is different from the above values, is adapted, it is necessary to perform the above-described performance test to determine a value of a coefficient of effective wall length.

As described above, the above gypsum board for structure and reinforced gypsum board specified in JIS A 6901 require the properties that include the area density of 9.4 kg/m² or greater and the specific gravity of 0.75 or greater. These properties have been considered as important conditions for increasing a maximum load that a board can endure and securing a high short-term allowable shear strength of the wooden load-bearing wall (thereby, securing a high coefficient of effective wall length). In the gypsum board for structure that is required to achieve the higher lateral nail resistance than that of the reinforced gypsum board, it has been considered that the area density and the specific gravity cannot be reduced. Specifically, it has been considered that securing the properties that include the area density of 9.4 kg/m² or greater and the specific gravity of 0.75 or greater is an essential condition for further increasing a coefficient of effective wall length of a bearing wall test sample (wooden load-bearing wall) in the above-described in-plane shear test. However, the present inventors have found the following from the experiments conducted by the present inventors in recent years. When a thickness is reduced or a specific gravity of a gypsum core is reduced by adjusting an amount of air bubbles to reduce an area density of the gypsum-based board to which physical properties (lateral nail resistance) comparable to those of the gypsum board for structure are imparted by adding inorganic fibers or an organic strength improver, a toughness or shape conformability upon deformation that the board intrinsically has is manifested. As a result, the ultimate strength of the bearing wall can be effectively utilized and the ductility factor of the bearing wall can be increased, thereby further improving a short-term allowable shear strength of the bearing wall. This point is as described in detail in Patent Document 3. Hereinafter, an outline of the in-plane shear test of the wooden load-bearing wall will be described, and general matters related to increase in a ductility factor of the bearing wall due to increase in the ultimate strength of the bearing wall, and improvement in the short-term allowable shear strength and coefficient of effective wall length of the bearing wall accompanying the increase of the ductility factor will be described as a reference.

[Regarding Test Sample of in-Plane Shear Test of Wooden Load-Bearing Wall]

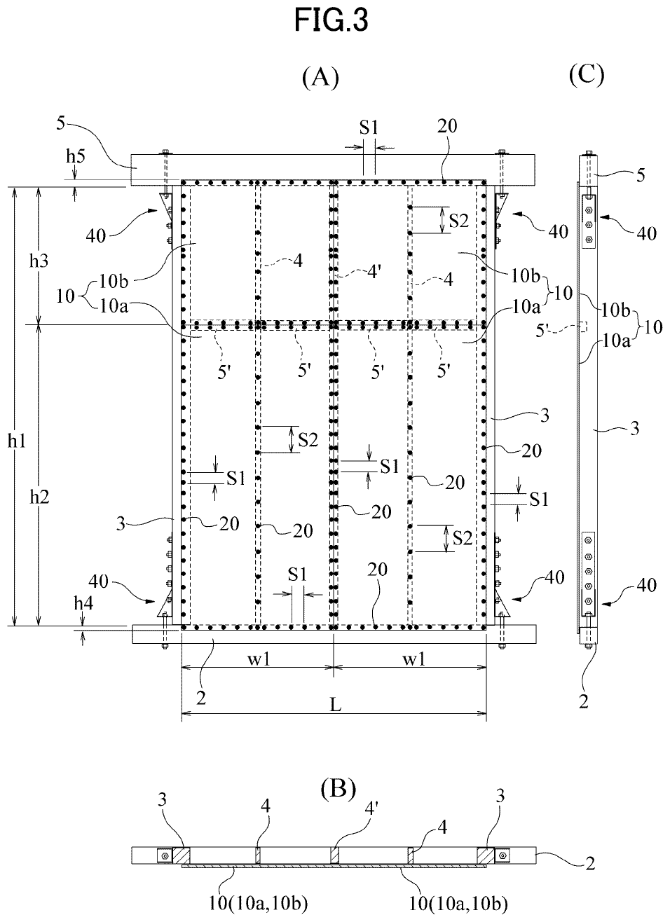

FIG. 3 is a front view and a side view illustrating a configuration of the bearing wall test sample used in the in-plane shear test in association with the bearing wall structure illustrated in FIG. 1.

In FIG. 3, constituent components or constituent members of a bearing wall test sample corresponding to or equivalent to constituent components or constituent members illustrated in FIGS. 1 and 2 are provided with the same reference numerals.

The present inventors prepared, as a test sample of the bearing wall structure illustrated in FIG. 1, a bearing wall test sample having a bearing wall structure illustrated in FIG. 3 having a width of 1,820 mm and a height of 2,730 mm (merely referred to as a “test sample” hereinafter) according to the test sample specifications described in “Wooden bearing walls and operational procedures of testing and evaluating magnifications and performance thereof”, and conducted an in-plane shear test using a no-load tester.

The test sample illustrated in FIG. 3 has a main structural portion of a wooden framework including a sill plate 2 and posts 3, which are cedar timber having a cross-section of 105 mm×105 mm, and a horizontal member 5, which is supported by the posts 3 and is Douglas fir timber having a cross-section of 180 mm×105 mm. A joint stud 4 that is cedar timber having a cross-section of 45 mm×105 mm is put up at a central part between the posts 3, and studs 4 that are cedar timber having a cross-section of 27 mm×105 mm are each put up between the post 3 and the joint stud 4′. The tie beams 5′, which are cedar or Douglas fir timber, are laid between the post 3 and the stud 4, and are laid between the stud 4 and the joint stud 4′. As a testing jig, drawing metals 40 are provided at joints between the sill plate 2 and the post 3, and also provided at joints between the horizontal member 5 and the post 3. The sill plate 2, the posts 3, the joint stud 4′, the studs 4, the horizontal member 5, and the tie beams 5′ constitute frame members of the bearing wall structure, and these members (frame members) form a rectangular framework.

In the test sample illustrated in FIG. 3, a vertical clearance h1 between the sill plate 2 and the horizontal member 5, a height h2 of the tie beam 5′, and a relative height h3 of the horizontal member 5 relative to the tie beam 5′ are set at 2,625 mm (h1), 1,790 mm (h2), and 835 mm (h3), respectively, and a gap w1 between the post 3 and the joint stud 4′ (post-core gap) is set at 910 mm (w1), and a length L of the wall is set at 1.82 m. The board 10 is divided into an upper side and a lower side with the tie beams 5′. The lower side board 10a has dimensions of 910 mm in width and 1,820 mm in height, and the upper side board 10b has dimensions of 910 mm in width and 865 mm in height. Overlap allowance dimensions h4 and h5 of the boards 10a and 10b are set at 30 mm.

In the test sample illustrated in FIG. 3, nails 20 for fastening the boards 10a and 10b to the sill plate 2, the posts 3, the joint stud 4′, the horizontal member 5, and the tie beams 5′ are arranged at equal intervals (gap S1 of 75 mm) along the peripheral zone of the boards 10a and 10b. Nails 20 for fastening the boards 10a and 10b to the studs 4 are arranged at equal intervals (gap S2 of 150 mm) in a vertically central zone of the boards 10a and 10b.

### [Description of Short-Term Allowable Shear Strength and Coefficient of Effective Wall Length of Wooden Load-Bearing Wall (Premise of Present Disclosure)]

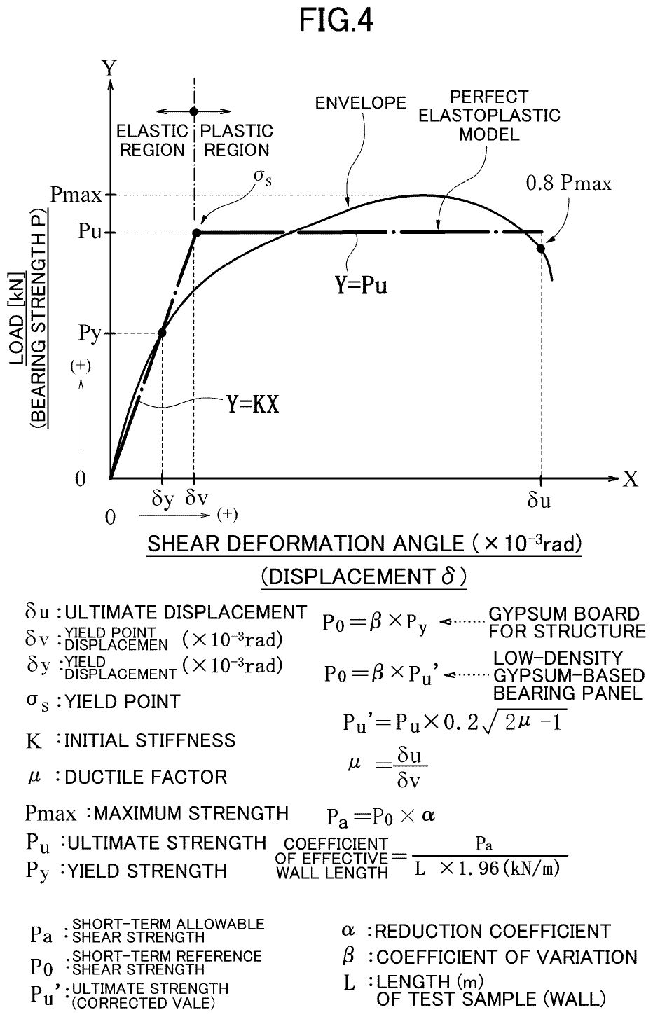

FIG. 4 is a graph and a line graph illustrating the test results of the in-plane shear test using an arbitrary gypsum-based load-bearing bearing board. In FIG. 4, a load-deformation angle curve typically obtained by the in-plane shear test is presented as an envelope (indicated with a solid line). With reference to FIG. 4, the in-plane shear test of the wooden load-bearing wall will be described, and methods for determining a short-term allowable shear strength and a coefficient of effective wall length of the wooden load-bearing wall will be described.

In FIG. 4, a line graph obtained by converting the envelop of the load-deformation angle curve into load-deformation angle characteristics of a perfect elastoplastic model is indicated with a dot-dash line. The perfect elastoplastic model is composed of a straight line of linear function (Y=KX) in the linear elastic region, which indicates an initial stiffness K, and a straight line (Y=Pu) in a plastic deformation region (ductile region), which extends parallel to the X-axis from a yield point σs. The yield point σs represents the elastic limit. The initial stiffness K is a coefficient indicating the slope of the straight line of the linear function (Y=KX) in the elastic region. The area of the region surrounded by the envelope, the X-axis, and a line segment of X=δu on the graph is substantially equal to the area of the region surrounded by the X-axis, a line segment of Y=KX, a line segment of Y=Pu, and a line segment of X=δu on the graph. Note that, the method of converting the envelope into the perfect elastoplastic model is described in various literatures, such as “Wooden bearing walls and operational procedures of testing and evaluating magnifications and performance thereof” and has been well known in material mechanics, and therefore further description thereof will be omitted.

FIG. 4 depicts the maximum strength Pmax, the 0.8 Pmax load reduction region, the ultimate strength Pu, the yield strength Py, the ultimate displacement δu, the yield point displacement δv, and the yield displacement δy. The ultimate displacement δu and the yield point displacement δv are a value of the deformation angle at the 0.8 Pmax load reduction range, and a value of the deformation angle at the yield point σs, respectively. The yield displacement δy is a value of the deformation angle at the time of appearance of the yield strength Py. Moreover, the ductility factor μ is a value (ratio) of the ultimate displacement δu/the yield point displacement δv. When the load (strength) is reduced to 0.8 Pmax after reaching the maximum strength Pmax, the wall is regarded as being substantially lost the load-bearing strength thereof, and therefore the in-plane shear test is substantially ended in the 0.8 Pmax load reduction region.

As described in various technical literatures, such as pages 63 and 300 of “Allowable stress design of houses constructed by a wooden framework construction system [1] (2017 edition)” (Non-Patent Document 1), the coefficient of effective wall length is a value determined by calculating a short-term allowable shear strength (Pa) based on the strength Pmax, Pu, and Py, and displacements δu, δv, and δy specified by the perfect elastoplastic model depicted in FIG. 4, and dividing the calculated value by predetermined strength (wall length L (m)×1.96 (KN/m)). Specifically, the coefficient of effective wall length is an indexed value obtained by dividing the short-term allowable shear strength (Pa) with the above reference value (1.96 L).

This point will be described in detail. In the calculation of the coefficient of effective wall length, the smallest value among values of the following 4 types of strength is determined as the short-term reference shear strength (P0) in principle, and the short-term reference shear strength (P0) is multiplied by a predetermined reduction coefficient (α) (a coefficient for evaluating a factor of reduction in strength). In the case of a gypsum-based load-bearing bearing board, generally, the strength of the following (1) or (2), i.e., the yield strength (Py) or the ultimate strength (corrected value) (Pu′) has the smallest value. Note that, the value of the short-term reference shear strength (P0) determined from the following strength values (Py, Pu, and Pmax) is a value obtained by multiplying the following value by a coefficient of variation (β).
(1) Yield strength (Py)
(2) Ultimate strength (Pu) corrected based on the ductile factor (μ) (referred to as “ultimate strength (corrected value) (Pu′)” hereinafter)
(3) A value of ⅔ of the maximum strength (Pmax)
(4) Strength at a shear deformation angle of 1/120 rad (in case of a no-load or load system)

Generally, the short-term reference shear strength (P0) of the wooden structure wall base in which the above-described gypsum board for structure (Patent Document 2) is fastened with fasteners is determined by the yield strength (py) among the above 4 types of the strength (P0=β×Py). As described above, the coefficient of effective wall length is a value obtained by multiplying the short-term reference shear strength (P0) by the reduction coefficient (α), and dividing the calculated value by the predetermined strength (1.96 L), and therefore, the coefficient of effective wall length of the bearing wall in which the gypsum board for structure is fastened onto the wooden structure wall base with the fasteners is proportional to the yield strength (Py).

For the short-term reference shear strength (P0) of the bearing wall, in which the gypsum-based board disclosed in Patent Document 3, i.e., the above-described low-density gypsum-based load-bearing bearing board, is fastened onto the wooden structure wall base with the fasteners, generally, the ultimate strength (corrected value) (Pu′) exhibits the smallest value among the values of the above 4 types of strength. Therefore, the short-term reference shear strength (P0) for calculating a coefficient of effective wall length, and the coefficient of effective wall length are proportional to the ultimate strength (corrected value) (Pu′), which is different from the gypsum board for structure. As an unexpected effect from the low density of the low-density gypsum-based load-bearing bearing board, toughness and shape conformability upon deformation, which the gypsum-based load-bearing bearing board intrinsically has, are manifested owing to reduction in area density, thereby increasing the ultimate displacement (δu) of the bearing wall so that a value of the ultimate displacement (δu) greater than 20×10⁻³ rad is obtained. As a result, the bearing wall, in which the low-density gypsum-based load-bearing bearing board of Patent Document 3 is fixed to the wooden structure wall base, exhibits the ultimate strength (corrected value) (Pu′) of greater than 7.6 kN. As described above, the low-density gypsum-based load-bearing bearing board therefore exhibits strength comparable to that of the gypsum board for structure, although the area density of the low-density gypsum-based load-bearing bearing board is reduced compared with that of the gypsum board for structure.

The ultimate strength (corrected value) (Pu′) is a value determined based on the ultimate strength (Pu) and the ductility factor (μ) according to the following equation. The short-term reference shear strength (P0) is a value determined based on the ultimate strength (corrected value) (Pu′) and a coefficient of variation (β) of the measured value according to the following equation.

$$\begin{matrix}{Pu}^{′} = Pu \times 0.2 \times ( 2 μ - 1 ) 1 / 2 \\ P 0 = β \times {Pu}^{′}\end{matrix}$$

Specifically, use of the gypsum-based load-bearing bearing board (i.e., a low-density gypsum-based load-bearing bearing board) of Patent Document 3, in which the area density is reduced to manifest toughness or shape conformability upon deformation that the board intrinsically has can increase the ultimate displacement (δu) of the bearing wall to a value of greater than 20×10⁻³ rad. As a result, the ductility factor μ=(=δu/δv) is increased to increase the ultimate strength (corrected value) (Pu′), thereby increasing the short-term reference shear strength (Pa) so that the coefficient of effective wall length is increased. The present inventors further studied the fastening structure of the board and the ductility factor μ for further increasing a short-term allowable shear strength (Pa) and a coefficient of effective wall length, and found that the initial stiffness is increased by changing the dimensions and shape of the nail 20, thereby increasing the ductility factor μ. The present invention has been accomplished based on this insight. This point will be described hereinafter.

### [Regarding Dimensions and Shape of Nail 20]

In an existing wooden bearing wall, in which a gypsum-based load-bearing bearing board is fixed to a framework or frame of a wooden structure, a gypsum-based load-bearing bearing board is typically fixed to the framework or the frame by NZ50 nails (round plated-iron nails: JIS A 5508). The NZ50 nail has dimensions (JIS A 5508) of 6.6 mm in head diameter, 2.75 mm in body diameter, and 50 mm in nail length, and a ratio η of the head area to the body cross-sectional area is 5.76. In the in-plane shear test using a test sample of a wooden bearing wall in which a low-density gypsum-based load-bearing bearing board is fixed onto a wooden structure framework or frame by the above nails, as described in Patent Document 3, an ultimate displacement (δu) is increased, thereby increasing ultimate strength (corrected value) (Pu′), a short-term reference shear strength (P0), and a coefficient of effective wall length. In the in-plane shear test, however, the following characteristics are observed. A nail hole is broken by the pressure repetitively applied to the test sample to cause a punching shear phenomenon. A resulting punch-out fracture of the gypsum-based load-bearing bearing board rapidly decreases strength of the test sample to Pu=0.8 Pmax, thereby ending the in-plane shear test. Therefore, it is considered that the short-term reference shear strength (Pa) and the coefficient of effective wall length cannot be further increased unless breakage or rapture of nailed portions is inhibited to inhibit a punch-out fracture of the gypsum-based load-bearing bearing board. As in the board reinforcement method described in Patent Document 1, it may be possible to inhibit or minimize punch-out fractures by providing a reinforcement material or a stiffener, such as a metal plate or the like, to a nailing portion. However, the attachment or arrangement of the reinforcement material or stiffener is a factor for making a production process of the gypsum-based board complicated, and impairing walkability of construction work as described above.

FIG. 5 is a table presenting, as a comparison table, a head diameter D, a body diameter d, a length L, and an area ratio of a head area to a body cross-sectional area n for the nail 20 constituting the bearing wall according to an example of the present disclosure, and each of nails N1 and N2 constituting bearing walls according to comparative examples. The values of the head diameter D, the body diameter d, the length L, and the area ratio η of the head area to the body cross-sectional area of the nail 20 are as described above. The nail N1 is an iron nail distributed in the market as an NZ50 nail (JIS A 5508), and the values thereof presented in FIG. 5 (head diameter D of 6.62 mm, body diameter of 2.83 mm, and area ratio η (head area/body cross-sectional area) of 5.48) are each an average of measurement values determined by measuring dimensions of corresponding portions of acquired 10 NZ50 nails in the market, which are slightly different from the values specified in JIS A 5508. The nail N2 is an iron nail distributed in the market as a CN50 nail (JIS A 5508), and the values thereof presented in FIG. 5 (head diameter D of 6.67 mm, body diameter d of 2.92 mm, and area ratio η (head area/body cross-sectional area) of 5.2) are each also an average of measurement values determined by dimensions of corresponding portions of acquired 10 CN50 nails in the market, which are slightly different from the values specified in JIS A 5508. All of the nail 20, N1, N2 has a length L of approximately 50 mm.

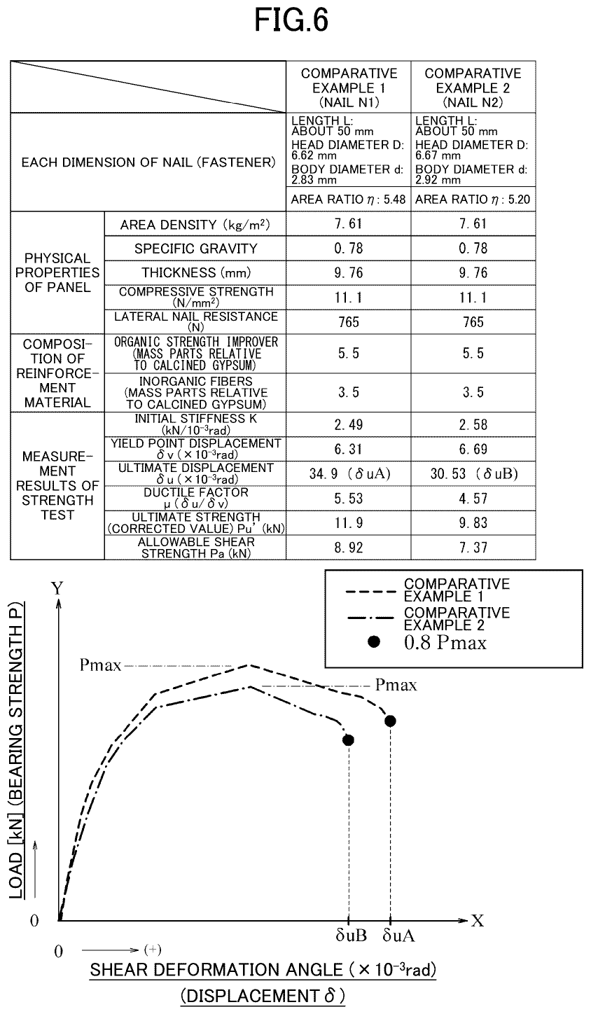

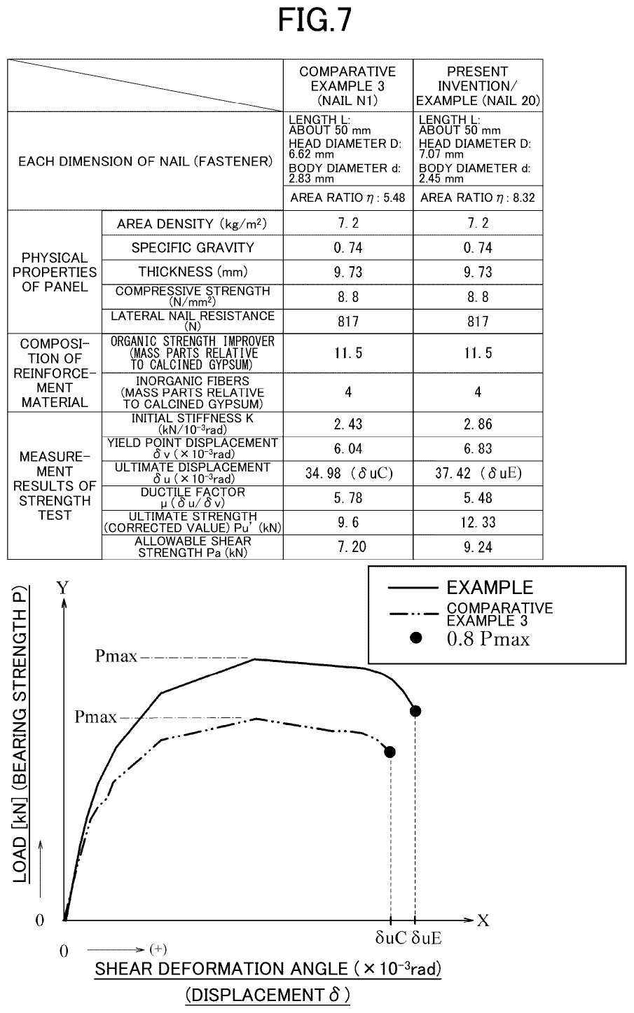

FIG. 6 is a table and a line graph for comparing the test results of the in-plane shear test of the bearing wall using the nails N1 (Comparative Example 1) and the bearing wall using the nails N2 (Comparative Example 2). FIG. 7 is a table and a line graph for comparing the test results of the in-plane shear test of the bearing wall using the nails 20 (the embodiment of the present disclosure) and the bearing wall using the nails N1 (Comparative Example 3). Each of the gypsum-based load-bearing bearing boards 10 of the present embodiment and Comparative Examples 1 to 3 is a low-density gypsum-based load-bearing bearing board including a flat board gypsum core (gypsum core material) 11 to which predetermined amounts of inorganic fibers (glass fibers) and an organic strength improver (starch) are added, and a base paper (paper member) for gypsum board 12 covering both surfaces of the gypsum core. Each of the gypsum-based load-bearing bearing boards 10 of the present embodiment and Comparative Examples 1 to 3 has an area density within the range of from 6.5 kg/m² to 8.9 kg/m², a compressive strength of 6.5 N/mm² or greater, and a lateral nail resistance of 500 N or greater.

As is clear from the test results presented in FIG. 6, the present inventors have confirmed that, in the case of the gypsum-based load-bearing bearing board, thick nails (Comparative Example 2 having the body diameter d greater than that of Comparative Example 1) are not necessarily effective for inhibiting punch-out fractures (thus, not necessarily effective for improving a short-term allowable shear strength (Pa) and a coefficient of effective wall length). As is clear from the test results presented in FIG. 7, the present inventors have also confirmed that, in the case of the gypsum-based load-bearing bearing board, punch-out fractures of the gypsum-based load-bearing bearing board can be inhibited or minimized, and the short-term allowable shear strength (Pa) and the coefficient of effective wall length can be relatively significantly improved by appropriately setting the head diameter D, the body diameter d, and the ratio η of the head area to the body cross-sectional area. This point will be described with reference to FIGS. 6 and 7 hereinafter.

Generally, the head diameter D and the body diameter of the nail N2 (Comparative Example 2) are greater than the head diameter D and the body diameter d of the nail N1 (Comparative Example 1). Therefore, it is generally considered that the nail N2 is advantageous for inhibiting or minimizing punch-out fractures and exhibits an excellent shear strength compared to the nail N1 (thin nail) having a relatively small body diameter d. In the case of the low-density gypsum-based load-bearing bearing board in which the compressive strength and the lateral nail resistance are improved, on the contrary, it has been however found that the nail N2 decreases the short-term allowable shear strength (Pa) (thus, decreasing the coefficient of effective wall length). This is because a punching shear phenomenon occurs at a relatively early stage in the in-plane shear test, the strength (load) is reduced to Pu=0.8 Pmax (ultimate displacement: δuB<δuA) at the early stage by breakage or rapture of a nailed portion due to the punch-out fracture, and the strength of the wall itself is substantially lost.

When the bearing wall of the present example using the nails 20 is compared with the bearing wall of Comparative Example 3 using the nails N1, conversely, the body diameter d of the nail 20 is smaller than the body diameter d of the nail N1 (Comparative Example 3) and is a thin nail generally regarded as exhibiting the lower shear strength than that of the nail N, but such existing perception or insights are not necessarily applied to the case of the low-density gypsum bearing board, in which the compressive strength and lateral nail resistance are increased, as presented in FIG. 7. As presented in FIG. 7, the nail 20 contributes increase of the short-term allowable shear strength (Pa) (thus, increasing the coefficient of effective wall length) compared with the nail N1. This is considered to be a result that a difference between the body diameter d and the head diameter D of the nail 20 is increased according to the difference defined by the area ratio η of the head area to the body cross-sectional area, and as a result, an occurrence of a punching shear phenomenon is delayed, thereby delaying the timing of reduction in the strength (load) (Pu=0.8 Pmax) due to breakage or rapture of the nailed portion by the punch-out fracture. Therefore, the ultimate displacement is increased (δuE>δuC).

Accordingly, by setting the head diameter D and the body diameter d at 7.07 mm and 2.45 mm, respectively, and setting the head area/body cross-sectional area at 8.32, which increases a difference between the diameter of the head portion 21 and the diameter of the body portion 22 to sufficiently secure an annular and flat bearing surface 21b (see FIG. 2) borne on the surface of the low-density gypsum-based load-bearing bearing board, a short-term allowable shear strength (Pa) of the bearing wall using the low-density gypsum-based load-bearing bearing board, in which the compressive strength and lateral nail resistance are increased, can be effectively increased (thus, effectively increasing the coefficient of effective wall length). However, the following conditions need to be considered in combination with the increase in difference between the diameter of the head portion 21 and the diameter of the body portion 22.
(1) Setting the head diameter D at 10 mm or less, and preferably 9 mm or less, for inhibiting a splitting phenomenon of the board 10 caused by an action of penetration of a nail during nailing, and considering the head diameter D of the nail suitable for use by a nailing machine.
(2) Setting the head diameter D at 6 mm or greater, and suitably 6.8 mm or greater, for inhibiting a punching shear phenomenon to minimize an action of a punch-out fracture.
(3) Setting the body diameter d at 5 mm or less, and preferably 4.2 mm or less, for inhibiting an phenomenon of splitting the board 10 by an action of penetration of the nail during nailing, and inhibiting occurrences of an edge breakage phenomenon of the board during the in-plane shear test.
(4) Setting the body diameter d at 2 mm or greater, and preferably 2.2 mm or greater, for inhibiting occurrences of excessive flexural deformation of the nail during the in-plane shear test.
(5) Setting the ratio η of the head area to the body cross-sectional area at 13 or less, and preferably 11 or less, for inhibiting extreme reduction in strength of the neck portion 23.
(6) Setting the ratio η of the head area to the body cross-sectional area at 6 or greater, and preferably 7 or greater, for assuring an effect of inhibiting a punching shear phenomenon.

In the bearing wall 1 using the low-density gypsum-based load-bearing bearing board, in which the compressive strength and the lateral nail resistance are increased, therefore, the head diameter D, the body diameter d, and the ratio η of the head area to the body cross-sectional area are set in appropriate numerical ranges, thereby inhibiting the head portion 21 (nail head) from sinking into the board 10, inhibiting or minimizing a punching shear phenomenon, and inhibiting splitting of the board 10 or the like caused during nailing, and therefore the short-term allowable shear strength (Pa) of the bearing wall 1 can be effectively increased (thus, effectively increasing the coefficient of effective wall length). In the case of the gypsum-based load-bearing bearing board 10, particularly, nailing needs to be performed in a manner such that the head portion 21 is positioned in the same plane as the board surface, and a covering material (base paper for gypsum board) 12 of the board 10 is not broken or damaged. In particular, in the case where the head portion 21 has an excessively large head diameter D, a phenomenon of splitting the board 10 is not easily caused ((1) above) when the top surface 21a of the head portion 21 and the surface of the board 10 are aligned on the same plane. From the viewpoint of avoiding such a phenomenon, the setting of the head diameter D, the body diameter d, and the ratio η of the head area to the body cross-sectional area is important.

### [Regarding Increase in Initial Stiffness by Increase in Compressive Strength and Increase in Short-Term Allowable Shear Strength Pa and Coefficient of Effective Wall Length]

The present inventors have recognized that a short-term allowable shear strength Pa and coefficient of effective wall length of a bearing wall 1 can be increased by that a low-density bearing board 10, in which a compressive strength and lateral nail resistance are improved, is fixed on a framework or frame of a wooden structure using the nails 20 having specific dimensions and shapes as described above. The present inventors have further recognized that the short-term allowable shear strength Pa and the coefficient of effective wall length of the bearing wall 1 can be also increased by increasing the initial stiffness of the board interdependently with the increase in the compressive strength. Specifically, by using the nails 20 having the specific dimensions and shapes and the low-density bearing board 10 in which the compressive strength and the lateral nail resistance are increased, the initial stiffness of the board is increased to increase a ductility factor μ, as well as inhibiting or minimizing a punching shear phenomenon. As a synergetic effect of the both, the short-term allowable shear strength Pa and the coefficient of effective wall length can be effectively or efficiently increased. An action of increasing the initial stiffness of the bearing board 10 interdependently with the increase in compressive strength, and increase in short-term allowable shear strength Pa and coefficient of effective wall length owing to the increase of the initial stiffness will be described hereinafter.

As described above, the compressive strength and lateral nail resistance of the gypsum-based load-bearing bearing board 10 can be increased by feeding an organic strength improver, such as a starch, polyvinyl acetate, polyvinyl alcohol, polyacrylics, or the like, together with inorganic fibers, to a gypsum slurry kneading mixer so as to add appropriate amounts of the organic strength improver and the inorganic fibers to the gypsum slurry. The addition of the organic strength improver to the gypsum slurry is an effective measure for imparting a desired compressive strength (compressive strength of 6.5 N/mm² or greater) to the gypsum-based load-bearing bearing board 10, while securing a relatively low area density (are density within the range of from 6.5 kg/m² to 8.9 kg/m²), and imparting a desired lateral nail resistance (lateral nail resistance of 500 N or greater) to the gypsum-based load-bearing bearing board 10 in cooperation with the inorganic fibers. In addition, considering the point such that the addition of the organic strength improver does not affect an overall quality of the gypsum-based load-bearing bearing board, the addition of the organic strength improver is a simple and realistic or practically effective measure.

In addition, it has been found from the experiments conducted by the present inventors in recent years that the increase in the compressive strength of the bearing board 10 contributes increase in initial stiffness K of the bearing wall 1, thereby reducing the yield point displacement δv without significantly reducing the ultimate displacement δu of the bearing wall 1, and as a result, the ductility factor μ of the bearing wall 1 is relatively significantly increased, thereby increasing the short-term allowable shear strength Pa and the coefficient of effective wall length, as described hereinafter.

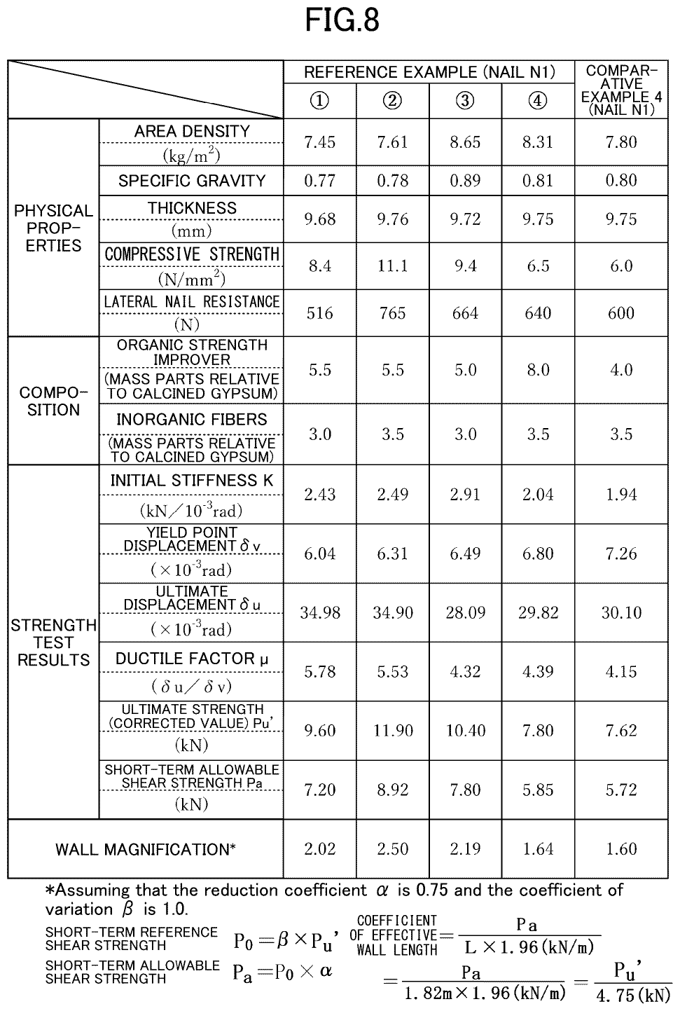

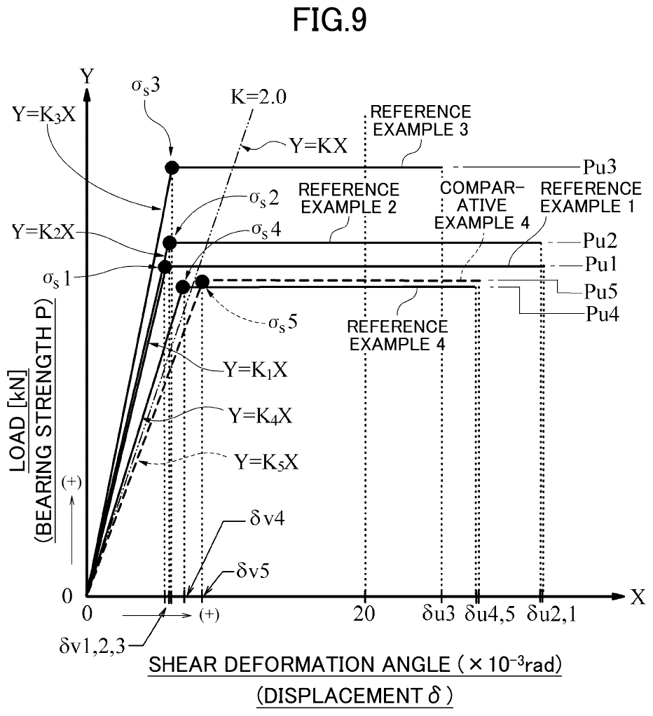

The present inventors produced gypsum-based load-bearing bearing boards of Reference Examples 1 to 4 and Comparative Example 4 presented in Table of FIG. 8 as samples, and an in-plane test was performed using a no-load tester. The amounts of the inorganic fibers and the organic strength improver presented in FIG. 8 are represented by parts by weight relative to 100 parts by weight of the calcined gypsum 100. As described above, the gypsum-based load-bearing bearing board of Comparative Example 4 is a board including a flat board gypsum core (gypsum core material) to which predetermined amounts of the inorganic fibers (glass fibers) and the organic strength improver (starch) are added, and base paper (paper member) for a gypsum board covering the both surfaces of the gypsum core. Each gypsum-based load-bearing bearing board has an area density within the range of from approximately 7.4 kg/m² to approximately 8.7 kg/m², increases the ultimate displacement δu and ductility factor μ of the wooden load-bearing wall compared with the gypsum-based load-bearing bearing board of the related art (Patent Document 4), and has a performance of increasing a short-term allowable shear strength Pa and a coefficient of effective wall length. However, the gypsum-based load-bearing bearing boards of Reference Examples 1 to 4 and Comparative Example 4 are each fastened to the sill plate 2, the posts 3, studs 4, the joint stud 4′, the horizontal member 5, and the tie beams 5′ (wooden framework illustrated in FIG. 3) with nails N1 (NZ50 nails) of the related art not with the nails 20 according to the present disclosure. This is for removing any effect of influence of use of the nails 20, and evaluating only increase of the initial stiffness K of the bearing wall 1 due to increase in compressive strength of the bearing board 10 (thus, increasing a ductility factor μ of the bearing wall 1), and increase of a short-term allowable shear strength Pa and a coefficient of effective wall length due to the above increase. The bearing walls having the performance presented in FIGS. 8 and 9 do not have a structure in which the bearing board 10 is fastened onto the wooden framework using the nails 20 according to the present disclosure, and therefore presented as Reference Examples 1 to 4 in FIGS. 8 and 9.

Referring to the test results presented in FIGS. 8 and 9, the test results of each of the test samples of Reference Examples 1 to 4 and Comparative Example 4 demonstrate that, after reaching the maximum load (maximum strength) Pmax (FIG. 3) in the vicinity of the deformation angle at 20×10⁻³ rad, the test sample does not immediately break, and then reaches an deformation angle of the 0.8 Pmax load reduction range, i.e., an ultimate displacement of from δu1 to δu5 (FIG. 9) by repetitively applied pressure, where the ultimate displacement δu1 to δu5 is a deformation angle of approximately 30×10⁻³ rad. This means that, after reaching the maximum load (maximum strength) Pmax, each of the test samples of Reference Examples 1 to 4 and Comparative Example 4 continues plastic deformation by repetitively applied pressure until the deformation angle of approximately 1.5 times the deformation angle at the maximum load Pmax is formed. This continuity of the plastic deformation is considered to be due to the fact that, as described above, the area density is reduced while securing the minimum physical property (lateral nail resistance: 500 N or greater) as the gypsum-based load-bearing bearing board so that toughness and shape conformability upon deformation that the gypsum board itself intrinsically has are manifested.

Comparing the compressive strength or the like of Reference Examples 1 to 4 with that of Comparative Example 4, the compressive strength of the gypsum-based load-bearing bearing board of Comparative Example 4 is 6.0 N/mm², and is relatively low compared with the compressive strength (6.5 N/mm² or greater) of the gypsum-based load-bearing bearing boards of Reference Examples 1 to 4, and the short-term allowable shear strength Pa and coefficient of effective wall length of the gypsum-based load-bearing bearing board of Comparative Examples are relatively reduced compared with the gypsum-based load-bearing bearing boards of Reference Examples 1 to 4.

### [Measurement of Compressive Strength of Bearing Board]

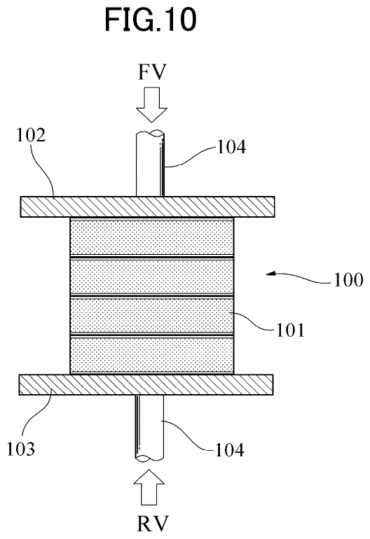

FIG. 10 schematically illustrates a measurement method of a compressive strength of the gypsum-based load-bearing bearing board.

In the measurement of the compressive strength of the gypsum-based load-bearing bearing board performed by the present inventors, as illustrated in FIG. 10, each of the gypsum-based load-bearing bearing boards of the example, reference examples, and comparative examples was cut into a flat board in the dimensions of 4 cm×4 cm to produce a plurality of test pieces 101 for each of the example, reference examples, and comparative examples, a test piece stack 100 formed by stacking four sheets of the identical test pieces 101 without bonding was interposed between upper and lower loading plates 102 and 103 of the measuring device. Then, a compressive load Fv (and reaction force Rv) was vertically applied to the test piece stack 100 by the upper and lower loading rods 104 to break the main material or core material formed of the hardened gypsum, i.e., the gypsum core portion of the sample piece 101, thereby measuring a compressive load Fv at the breakage. As the measuring device, a precision universal tester (“Autograph” produced by Shimadzu Corporation, model: AG-10NKI) was used. The present inventors measured the compressive load Fv at the point when any of the test pieces 101 constituting the test piece stack 100 was broken by compression, and determined the value obtained by dividing the measured value by an area (16 cm²) of the test piece 100 as a compressive strength of each gypsum-based load-bearing bearing board.

The compressive strength of each of the gypsum-based load-bearing bearing board of Reference Examples 1 to 4 and Comparative Example 4 determined in the above-described manner are presented in FIG. 8. As presented in FIG. 8, the initial stiffness K of the each of the gypsum-based load-bearing bearing boards of Reference Examples 1 to 4 and Comparative Example 4 changes substantially in response to the increase or decrease of the compressive strength, and a value of the initial stiffness K can be increased by increasing the compressive strength. As presented in FIG. 8, moreover, the ductility factor μ is changed in response to the increase or decrease of the initial stiffness K so that the values of the ultimate strength (corrected value) Pu′ and the short-term allowable shear strength Pa. According to the various physical properties of Reference Examples 1 to 4, as presented in FIG. 8, the value of the ultimate strength (corrected value) Pu′ that is 7.8 kN or greater (short-term allowable shear strength Pa of 5.85 kN or greater) can be obtained by increasing the compressive strength of the gypsum-based load-bearing bearing board at the value of 6.5 N/mm² or greater.

Specifically, the gypsum-based load-bearing bearing boards of Reference Examples 1 to 4 has the compressive strength of 6.5 N/mm² or greater, and a relatively high ductility factor μ due to increase in the initial stiffness K and the yield point displacement δv interdependently with the compressive strength. As a result, the ultimate strength (corrected value) Pu′ and the short-term allowable shear strength Pa of the test samples of Reference Examples 1 to 4 are Pu′ of from 7.8 kN to 11.9 kN and Pa of from 5.85 to 8.92, respectively, and these values are significantly increased compared with the ultimate strength (corrected value) (=7.62 kN) and the short-term allowable shear strength Pa (=5.72 kN) of the test sample of Comparative Example 4. Assuming that the reduction coefficient α is 0.75 and the coefficient of variation β is 1.0, moreover, the values of the coefficient of effective wall length of the test samples of Reference Examples 1 to 4 are in the range of from 1.64 to 2.50, which is significantly increased compared with the coefficient of effective wall length (1.60) of the test sample of Comparative Example 4. In other words, it is considered that the initial stiffness K of the bearing wall 1 is increased by the increased compressive strength of the bearing board 10, and as a result, the yield point displacement δv is reduced without significantly reducing the ultimate displacement δu of the bearing wall. Thus, the ductility factor μ (=δu/δv) of the bearing wall 1 is relatively significantly increased, thereby increasing the short-term allowable shear strength Pa and the coefficient of effective wall length.

[Regarding Increase in Ductility Factor μ Interdependent with Increase in Initial Stiffness K]

As described above, the ultimate strength (corrected value) Pu′ is a value of the ultimate strength Pu corrected based on the ductility factor μ, the short-term allowable shear strength Pa is a value obtained by multiplying the ultimate strength (corrected value) Pu′ by the predetermined reduction coefficient α and the coefficient of variation, and the coefficient of effective wall length is a value obtained by dividing the short-term allowable shear strength Pa by the predetermined strength reference value (L×1.96). Accordingly, the coefficient of effective wall length and the short-term allowable shear strength Pa are proportional to a value of the ultimate strength Pu, and increase interdependently with increase in the ductility factor μ. The ductility factor μ is a value that is proportional to the ultimate displacement δu and inversely proportional to the yield point displacement δv. Therefore, the coefficient of effective wall length and the short-term allowable shear strength Pa can be increased by increasing the ultimate displacement δu, or decreasing the yield point displacement δv.

In FIG. 9, the test result of each of the test samples of Reference Examples 1 to 4 and Comparative Example 4 is presented as a line graph of a load-deformation angle characteristics of the perfect elastoplastic model. In FIG. 9, moreover, a straight line of linear function (Y=KX) in the linear elastic region in which the initial stiffness K is set at 2.0 kN/10⁻³ rad is indicated with a two-dot dash line as a reference line of the initial stiffness K in the present disclosure. In FIG. 9, straight lines of linear function (Y=K1X) to (Y=K5X) in the linear elastic region, ultimate strength Pu1 to Pu5, and yield point σs1 to σs5 of the test samples of Reference Examples 1 to 4 and Comparative Example 4 are presented. As presented in FIG. 8, the initial stiffness of each of the test samples of Reference Examples 1 to 4 is 2.04 kN/10⁻³ rad (K4=2.04 kN/10⁻³ rad) as the minimum value, and 2.91 kN/10⁻³ rad (K3=2.91 kN/10⁻³ rad) as the maximum value. In comparison, the initial stiffness of the test sample of Comparative Example 4 is 1.94 kN/10⁻³ rad (K5=1.94 kN/10⁻³ rad). The initial stiffness K appears in FIG. 9 as the gradient of the straight line of linear function of Y=KX. For the test samples of Reference Examples 1 to 4 having the initial stiffness K at the value of 2.0 kN/10⁻³ rad or greater, each straight line of linear function of (Y=K1−4X) is presented as a straight line with a steeper gradient than the reference line of the initial stiffness K of 2.0 kN/10⁻³ rad in FIG. 9. In Comparative Example 4 having the initial stiffness K5 at the value less than 2.0 kN/10⁻³ rad, the straight line of linear function of (Y=K5X) is represented as a straight line with a milder gradient than the reference line of the initial stiffness of (K=2.0 kN/10⁻³ rad) in FIG. 9. Specifically, the test samples of Reference Examples 1 to 4, in which the compressive strength is increased, have the initial stiffness K1 to K4 at the value 2.0 kN/10⁻³ rad or greater, and as a result, relatively small yield point displacement δv1 to δv4 is obtained, so that the ultimate strength (corrected value) Pu′, the short-term allowable shear strength Pa, and the coefficient of effective wall length, which are relatively large compared with those of Comparative Example 4, are obtained interdependently with relatively large ultimate displacement δu1 to δu4 and ultimate strength Pu1 to Pu4, as presented in FIG. 8.

As presented in FIGS. 8 and 9, the initial stiffness K of each of the test samples of Reference Examples 1 to 4 is greater than 2.0 kN/10⁻³ rad, the initial stiffness K of the test sample of Comparative Example 4 is smaller than 2.0 KN/10⁻³ rad, the yield point displacement δv1 to δv4 of the test samples of Reference Examples 1 to 4 is slightly smaller than the yield point displacement δv5 of the test sample of Comparative Example 4. As presented in FIG. 8, the coefficient of effective wall lengths and short-term allowable shear strength Pa obtained by the test samples of Reference Examples 1 to 4 are significantly larger than the values of the coefficient of effective wall length and the short-term allowable shear strength Pa obtained by the test sample of Comparative Example 4. This is considered to be a result such that increase in the ductility factor μ due to reduction in the yield point displacement δv relatively largely contributes increase in the coefficient of effective wall length and the short-term allowable shear strength Pa.

As described above, the bearing wall according to the present embodiment has the following characteristics.
(1) The bearing board 10 includes a main material or a core material formed of a board-shaped hardened gypsum to which inorganic fibers and organic strength improver are added to achieve a lateral nail resistance of 500 N or greater and a compressive strength of 6.5 N/mm² or greater, and a paper member covering at least front and back surfaces of the main material or core material. The area density of the gypsum-based load-bearing bearing board 10 specified as a mass per unit area of a wall surface is set at a value within the range of 6.5 kg/m² to 8.9 kg/m². In a bearing wall using the low-density gypsum-based load-bearing bearing board 10, in which the compressive strength and the lateral nail resistance are increased as described above, a head portion 21 is inhibited from sinking into the board 10 by setting a head diameter D in the range of from 6.0 mm to 10.0 mm, a body diameter d in the range of from 2.0 mm to 5.0 mm, and a ratio η of a head area to a body cross-sectional area in the range of from 6 to 13, so that a punching shear phenomenon is inhibited or minimized, splitting of the board 10 caused during nailing is inhibited, and a short-term allowable shear strength Pa of the bearing wall 1 can be effectively increased (thus, effectively increasing a coefficient of effective wall length).
(2) In the bearing wall 1 using the low-density gypsum-based load-bearing bearing board 10, in which the compressive strength and the lateral nail resistance are increased as described above, the ultimate displacement du thereof is increased, for example, to the range of from 28.09×10⁻³ rad to 34.98×10⁻³ rad. Therefore, the ultimate displacement δu of the bearing wall 1 is significantly increased compared with the fact that the value of the ultimate displacement δu of the bearing wall using the existing gypsum-based load-bearing bearing board of the related art (e.g., the gypsum-based load-bearing bearing board described in Patent Document 4) is approximately 20×10⁻³ rad.
(3) In the bearing wall 1 using the low-density gypsum-based load-bearing bearing board 10, in which the compressive strength and the lateral nail resistance are increased as described above, as described above as the yield point displacement δv1 to δv4 of the bearing walls 1 according to Reference Examples 1 to 4 (FIGS. 8 and 9), the yield point displacement is decreased to the range of from 6.04×10⁻³ rad to 6.80×10⁻³ rad due to the increase in the initial stiffness K, and these values are significantly reduced values compared to the yield point displacement δv5 (=7.26×10⁻³ rad) of the bearing wall 1 according to Comparative Example 4. Specifically, the bearing boards 10 described in Reference Examples 1 to 4 above not only increase the ultimate displacement δu1 to δu4 of the bearing wall 1 to increase the ductility factor μ, but also increase the ductility factor μ through reduction in the yield point displacement δv1 to δv4 of the bearing wall 1, and therefore the coefficient of effective wall length and short-term allowable shear strength Pa can be relatively largely increased.

Although the preferred embodiments and examples of the present disclosure have been described in detail above, the present disclosure is not limited to the above-described embodiments and examples, and it is needless to say that various modifications or changes can be made within the scope of the present disclosure described in the claims.

For example, the above embodiments and examples are related to a bearing wall at a first floor level of a wooden structure building, but the present disclosure can be similarly applied for a bearing wall at a second or third flow level. In the case of the bearing wall at a second or third floor level, the lower end of the bearing board is fastened onto a horizontal member or the like of a second or third floor level.

Moreover, the above embodiments and examples are related to a wooden framework construction system and a bearing wall structure of large wall construction (wall with embedded posts), but the present disclosure may be applied for a bearing wall structure of Makabe construction (wall with exposed posts) or Tokogachi (floor preceding) large wall construction (wall with embedded posts) in a wooden framework construction system. As a modification example, the present disclosure may be applied for a bearing wall structure of a wood framing construction system. In this case, the bearing board is fastened onto a vertical frame, a lower frame, an upper frame, and the like, instead of the sill plate, the posts, and the horizontal members.

Further, the test sample illustrated in FIG. 3 has a structure where the gypsum board is divided into an upper side and a lower side, and tie beams are provided at the intermediate portion in the height direction, but an in-plane shear test may be performed using a gypsum board having substantially the same height as the total height of the wooden framework. In the latter case, it is considered that a short-term reference shear strength can be further increased.

### INDUSTRIAL APPLICABILITY

The present disclosure is applied for a wooden load-bearing wall of a wooden structure building and a construction method thereof. Moreover, the present disclosure is applied for a wooden load-bearing wall and a construction method thereof, in which a low-density gypsum-based load-bearing bearing board is fastened to a wooden structure wall base of a wooden framework construction system or a wood framing construction system with metal nails to support the gypsum-based load-bearing bearing board in a structurally integrated manner with the wooden structure wall base, where the gypsum-based load-bearing bearing board includes a main material or core material formed of board-shaped hardened gypsum to which inorganic fibers and an organic improver are added to achieve an area density in the range of from 6.5 kg/m² to 8.9 kg/m² and a lateral nail resistance of 500 N or greater. Further, the present disclosure is applied for a method of increasing a coefficient of effective wall length of a wooden load-bearing wall using the above gypsum-based load-bearing bearing board. The present disclosure is further applied to the above wooden load-bearing wall, a method of increasing the coefficient of effective wall length thereof, and a method of constructing the above wooden load-bearing wall. According to the present disclosure, the bearing board can be fastened onto the wooden structure base using the metal nails having specific shape and dimensions so that a coefficient of effective wall length of the wooden load-bearing wall can be increased without additionally attaching a reinforcement material or a stiffener, without increasing a specific gravity, thickness, or both of the gypsum-based board, and without further increasing a value of the ultimate displacement (δu). Therefore, the practical value or effect of the present disclosure is significant.

The present international application claims priority to Japanese Patent Application No. 2022-122390 filed on Jul. 30, 2022, and the entire contents of this application are incorporated into the present international application by reference.

### REFERENCE SIGNS LIST

1 bearing wall
2 sill plate
3 post
4 stud
4′ joint stud
5 horizontal member (beam, girding beam, pole plate, and end beam)
5′ tie beam
10, 10a, 10b gypsum-based load-bearing bearing board
11 flat board gypsum core (gypsum core material)
12 base paper (paper member) for gypsum board
20 nail (fastener)
21 head portion
21a top surface
21b bearing surface
22 body portion
23 neck portion
24 tip
D head diameter
d body diameter
L length
H area ratio of head area to body cross-sectional area

1. A wooden load-bearing wall, comprising
a gypsum-based load-bearing bearing board fastened onto a wooden structure wall base of a wooden framework construction system or a wood framing construction system with fasteners,
wherein the gypsum-based load-bearing bearing board includes a main material or a core material formed of a board-shaped hardened gypsum, and a paper member covering at least a front surface and a back surface of the main material or the core material,
the gypsum-based load-bearing bearing board has, as an area density or a weight per unit area of the gypsum-based load-bearing bearing board determined as a mass per unit area of a wall surface of the wooden load-bearing wall, the area density or the weight per unit area in a range of from 6.5 kg/m² to 8.9 kg/m², a lateral nail resistance of 500 N or greater, and a compressive strength of 6.5 N/mm² or greater,
each of the fasteners is a metal nail including a head portion and a body portion, in which an area ratio of an area of the head portion to a cross-sectional area of the body portion is set at a value in a range of from 6 to 13, and
as an ultimate displacement of the wooden load-bearing wall determined by measuring a bearing wall test sample having a length of 1.82 m by an in-plane shear test, the wooden load-bearing wall has a value of the ultimate displacement (δu) being greater than 20×10⁻³ rad.

2. The wooden load-bearing wall according to claim 1,
wherein the body portion of the nail is a straight and smooth body portion having a uniform circular cross-sectional surface and having a pointed tip, and the head portion of the nail is a head portion having a flat head shape or a flat meshed head shape and having a circular contour in a top view.

3. The wooden load-bearing wall according to claim 1,
wherein the nail has an annular and flat bearing surface borne on the gypsum-based load-bearing bearing board by nailing, and a flat top surface that is designed to be positioned substantially in a same plane as the wall surface constituted by an outer surface of the gypsum-based load-bearing bearing board after nailing.

4. The wooden load-bearing wall according to claim 1,
wherein the gypsum-based load-bearing bearing board has the compressive strength of 7.5 N/mm² or greater so that a value of an initial stiffness (K) of the wooden load-bearing wall measured by the in-plane shear test is 2.2 kN/10⁻³ rad or greater.

5. The wooden load-bearing wall according to claim 1,
wherein as properties of the wooden load-bearing wall measured by the in-plane shear test, at least one property selected from the group consisting of:
(1) a yield point displacement (δv) being 7.2×10⁻³ rad or less,
(2) a ductility factor (μ) being 4.2 or greater,
(3) a correction value (Pu′) of an ultimate strength (Pu) being 7.7 kN or greater, and
(4) a yield strength (Py) being a value that is 7.7 kN or greater and is greater than the correction value (Pu′) of the ultimate strength (Pu),
is attained by
setting of the area density or the weight per unit area and the lateral nail resistance, and
setting of a head diameter and a body diameter of the nail, and the area ratio of the area of the head portion to the cross-sectional area of the body portion, which are set for inhibiting a punching shear phenomenon or minimizing a punch-out fracture.

6. The wooden load-bearing wall according to claim 1,
wherein the gypsum-based load-bearing bearing board has a thickness of less than 12 mm, a specific gravity of 0.96 or less, or both,
wherein inorganic fibers, organic strength improver, or both are added to the main material or the core material of the gypsum-based load-bearing bearing board, and
wherein an organopolysiloxane compound is added to the main material or the core material of the gypsum-based load-bearing bearing board.

7. (canceled)

8. (canceled)

9. A method of constructing a wooden load-bearing wall, comprising:
fastening a gypsum-based load-bearing bearing board onto a wooden structure wall base of a wooden framework construction system or a wood framing construction system with fasteners,
where the gypsum-based load-bearing bearing board includes a main material or a core material formed of a board-shaped hardened gypsum, and a paper member covering at least a front surface and a back surface of the main material or the core material,
the gypsum-based load-bearing bearing board has, as an area density or a weight per unit area of the gypsum-based load-bearing bearing board determined as a mass per unit area of a wall surface of the wooden load-bearing wall, the area density or the weight per unit area in a range of from 6.5 kg/m² to 8.9 kg/m², a lateral nail resistance of 500 N or greater, and a compressive strength of 6.5 N/mm² or greater, and
each of the fasteners is a metal nail including a head portion and a body portion, in which an area ratio of an area of the head portion to a cross-sectional area of the body portion is set at a value in a range of from 6 to 13; and
constructing the wooden load-bearing wall having, as an ultimate displacement of the wooden load-bearing wall determined by measuring a bearing wall test sample having a length of 1.82 m by an in-plane shear test, a value of the ultimate displacement (δu) being greater than 20×10⁻³ rad.

10. The method of constructing wooden load-bearing wall, according to claim 9,
wherein the body portion of the nail is a straight and smooth body portion having a uniform circular cross-sectional surface and having a pointed tip, and the head portion of the nail is a head portion having a flat head shape or a flat meshed head shape and having a circular contour in a top view.

11. The method of constructing wooden load-bearing wall, according to claim 9,
wherein the nail has an annular and flat bearing surface borne on the gypsum-based load-bearing bearing board by nailing, and a flat top surface that is designed to be positioned substantially in a same plane as the wall surface constituted by an outer surface of the gypsum-based load-bearing bearing board after nailing.

12. The method of constructing wooden load-bearing wall, according to claim 9,
wherein the gypsum-based load-bearing bearing board has the compressive strength of 7.5 N/mm² or greater so that a value of an initial stiffness (K) of the wooden load-bearing wall measured by the in-plane shear test is 2.2 kN/10⁻³ rad or greater.

13. The method of constructing wooden load-bearing wall, according to claim 9,
wherein as properties of the wooden load-bearing wall measured by the in-plane shear test, at least one property selected from the group consisting of:
(1) a yield point displacement (δv) being 7.2×10⁻³ rad or less,
(2) a ductility factor (μ) being 4.2 or greater,
(3) a correction value (Pu′) of an ultimate strength (Pu) being 7.7 kN or greater, and
(4) a yield strength (Py) being a value that is 7.7 kN or greater and greater than the correction value (Pu′) of the ultimate strength (Pu),
is attained by
setting of the area density or the weight per unit area and the lateral nail resistance, and
setting of a head diameter and a body diameter of the nail, and the area ratio of the area of the head portion to the cross-sectional area of the body portion, which are set for inhibiting a punching shear phenomenon or minimizing a punch-out fracture.

14. The method of constructing wooden load-bearing wall, according to claim 9,
wherein the gypsum-based load-bearing bearing board has a thickness of less than 12 mm, a specific gravity of 0.96 or less, or both,
wherein inorganic fibers, an organic strength improver, or both are added to the main material or the core material of the gypsum-based load-bearing bearing board, and
wherein an organopolysiloxane compound is added to the main material or the core material of the gypsum-based load-bearing bearing board.

15. (canceled)

16. (canceled)

17. A method of increasing a coefficient of effective wall length of a wooden load-bearing wall that is constructed by fastening a gypsum-based load-bearing bearing board onto a wooden structure wall base of a wooden framework construction system or a wood framing construction system with fasteners, the method comprising:
constructing the gypsum-based load-bearing bearing board using a main material or a core material formed of a board-shaped hardened gypsum, and a paper member covering at least a front surface and a back surface of the main material or the core material;
setting a composition of the hardened gypsum of the main material or the core material so that an area density or a weight per unit area of the gypsum-based load-bearing bearing board determined as a mass per unit area of a wall surface is reduced to be in a range of from 6.5 kg/m² to 8.9 kg/m², and the gypsum-based load-bearing bearing board has a lateral nail resistance of 500 N or greater and a compressive strength of 6.5 N/mm² or greater;
using, as the fasteners, metal nails each including a head portion and a body portion, in which an area ratio of an area of the head portion to a cross-sectional area of the body portion is set at a value in a range of from 6 to 13, to inhibit a punching shear phenomenon or minimizing an action of a punch-out fracture; and
constructing the wooden load-bearing wall having, as an ultimate displacement of the wooden load-bearing wall determined by measuring a bearing wall test sample having a length of 1.82 m by an in-plane shear test, a value of the ultimate displacement (δu) being greater than 20×10⁻³ rad.

18. The method of increasing the coefficient of effective wall length of the wooden load-bearing wall, according to claim 17,
wherein the body portion of each of the nails is a straight and smooth body portion having a uniform circular cross-sectional surface and having a pointed tip, and the head portion of each of the nails is a head portion having a flat head shape or a flat meshed head shape and having a circular contour in a top view.

19. The method of increasing the coefficient of effective wall length of the wooden load-bearing wall, according to claim 17,
wherein each of the nails has an annular and flat bearing surface borne on the gypsum-based load-bearing bearing board by nailing, and a flat top surface that is designed to be positioned substantially in a same plane as the wall surface constituted by an outer surface of the gypsum-based load-bearing bearing board after nailing.

20. The method of increasing the coefficient of effective wall length of the wooden load-bearing wall, according to claim 17,
wherein the gypsum-based load-bearing bearing board has the compressive strength of 7.5 N/mm² or greater so that a value of an initial stiffness (K) of the wooden load-bearing wall measured by the in-plane shear test is 2.2 kN/10⁻³ rad or greater.

21. The method of increasing the coefficient of effective wall length of the wooden load-bearing wall, according to claim 17,
wherein as properties of the wooden load-bearing wall measured by the in-plane shear test, at least one property selected from the group consisting of:
(1) a yield point displacement (δv) being 7.2×10⁻³ rad or less,
(2) a ductility factor (μ) being 4.2 or greater,
(3) a correction value (Pu′) of an ultimate strength (Pu) being 7.7 kN or greater, and
(4) a yield strength (Py) being a value that is 7.7 kN or greater and greater than the correction value (Pu′) of the ultimate strength (Pu),
is attained by
setting of the area density or the weight per unit area and the lateral nail resistance, and
setting of a head diameter and a body diameter of each of the nails, and the area ratio of the area of the head portion to the cross-sectional area of the body portion, which are set for inhibiting a punching shear phenomenon or minimizing a punch-out fracture.

22. The method of increasing the coefficient of effective wall length of the wooden load-bearing wall, according to claim 17,
wherein the bearing board has a thickness of less than 12 mm, a specific gravity of 0.96 or less, or both,
wherein inorganic fibers, an organic strength improver, or both are added to the main material or the core material of the gypsum-based load-bearing bearing board, and
wherein an organopolysiloxane compound is added to the main material or the core material of the gypsum-based load-bearing bearing board.

23. (canceled)

24. (canceled)

25. A method of using a gypsum-based load-bearing bearing board for a wooden load-bearing wall, comprising:
using the gypsum-based load-bearing bearing board in the method of constructing the wooden load-bearing wall according to claim 9 the gypsum-based load-bearing bearing board having:
a lateral nail resistance of 500 N or greater, a compressive strength of 6.5 N/mm² or greater, and an area density or a weight per unit area in a range of from 6.5 kg/m² to 8.9 kg/m²,
wherein an ultimate displacement (δu) of the wooden load-bearing wall determined by measuring a bearing wall test sample having a length of 1.82 m by an in-plane shear test is increased to a value greater than 20×10⁻³ rad in cooperation with the fasteners.

26. The method according to claim 25,
wherein the gypsum-based load-bearing bearing board has a thickness of less than 12 mm, a specific gravity of 0.96 or less, or both.

27. The method according to claim 25,
wherein the gypsum-based load-bearing bearing board has the compressive strength of 7.5 N/mm² or greater so that a value of an initial stiffness (K) of the wooden load-bearing wall measured by the in-plane shear test is 2.2 kN/10⁻³ rad or greater.

28. The method according to claim 25,
wherein as properties of the wooden load-bearing wall measured by the in-plane shear test, at least one property selected from the group consisting of:
(1) a yield point displacement (δv) being 7.2×10⁻³ rad or less,
(2) a ductility factor (μ) being 4.2 or greater,
(3) a correction value (Pu′) of an ultimate strength (Pu) being 7.7 kN or greater, and
(4) a yield strength (Py) being a value that is 7.7 kN or greater and greater than the correction value (Pu′) of the ultimate strength (Pu),
is attained by
setting of the area density or the weight per unit area and the lateral nail resistance, and
setting of a head diameter and body diameter of each of the nails, and the area ratio of the area of the head portion to the cross-sectional area of the body portion, which are set for inhibiting a punching shear phenomenon or minimizing a punch-out fracture.

29. The method according to claim 25,
wherein the gypsum-based load-bearing bearing board has a lateral nail resistance of 980 N or less,
wherein inorganic fibers, an organic strength improver, or both are added to the main material or the core material of the gypsum-based load-bearing bearing board, and
wherein a organopolysiloxane compound is added to the main material or the core material of the gypsum-based load-bearing bearing board.

30. (canceled)

31. (canceled)
